(19) United States
(12) Patent Application Publication
(10) Pub. No.: US 2012/0293718 A1
(43) Pub. Date: Nov. 22, 2012

(54) LIGHTING DEVICE, DISPLAY DEVICE, AND TELEVISION RECEIVER

(75) Inventor: Satoshi Yoshida, Osaka-shi (JP)

(73) Assignee: SHARP KABUSHIKI KAISHA, Osaka-shi, Osaka (JP)

(21) Appl. No.: 13/521,309

(22) PCT Filed: Dec. 17, 2010
(86) PCT No.: PCT/JP2010/072762

§ 371 Date: Jul. 10, 2012

(30) Foreign Application Priority Data
Jan. 29, 2010 (JP) 2010-018575

(51) Int. Cl. F21V 21/00; H04N 5/44; G02F 1/13357; F21V 21/14; F21L 4/00

(52) U.S. Cl. 348/725; 362/382; 362/427; 362/191; 349/61; 348/E05.096

(57) ABSTRACT

Connection reliability of a terminal and other part is improved in a lighting device. A backlight unit includes a cold cathode tube having an outer lead at an end part; a chassis housing the cold cathode tube; and a connector mounted to the chassis and including an insertion path to which the outer lead is inserted, a connection terminal that expands to receive the outer lead inserted to the insertion path, and a restricting portion that is selectively moved in one of a first position and a second position. The restricting portion in the first position allows the outer lead to be inserted to the insertion path and allows the connection terminal to expand to receive the connection terminal. The restricting portion in the second position restricts the outer lead to be inserted to the insertion path and restricts expansion of the connection terminal that holds the outer lead.

### TECHNICAL FIELD

The present invention relates to a lighting device, a display device and a television receiver.

### BACKGROUND ART

For example, a liquid crystal panel used for a liquid crystal display device such as a liquid crystal television set does not emit light by itself and therefore separately requires a backlight unit as a lighting device. This backlight unit is installed on a rear side of the liquid panel (side opposite to a display surface) and includes a chassis having an opening on a surface close to the liquid crystal panel side, a plurality of cold cathode tubes housed in the chassis, a plurality of optical members (such as a diffuser sheet) arranged in the opening of the chassis so as to efficiently radiate light emitted from the cold cathode tubes to the liquid crystal panel side, an inverter board that can supply electric power to each cold cathode tube, and a connector that electrically connects the cold cathode tubes and the inverter board.

Patent Document 1 discloses a specific structure of the connector of the backlight unit. The connector includes connection terminals that sandwich an outer lead provided in an end part of a cold cathode tube and an operation member having a pressure portion to pressurize the connection terminals sandwiching the outer lead. This structure enhances a sandwiching force with which the connection terminals sandwich the outer lead.

Patent Document 1: Japanese Unexamined Patent Publication No. 2007-48716

### Problem to be Solved by the Invention

Meanwhile, it is concerned that, if large vibration or impact is applied during transportation of a liquid crystal display device, an outer lead sandwiched by connection terminals is disengaged from the connection terminals and a connection state is cancelled. In Patent Document 1, the connection terminals are pressurized by the pressure portion to achieve the configuration of enhancing the sandwiching force with which the connection terminals sandwich the outer lead. However, it does not specifically maintain vibration resistance performance or impact resistance performance for great vibration or impact that may be caused during transportation. Therefore, the above structure may not reliably prevent disengagement of the outer lead. Therefore, connection reliability may be further improved.

### DISCLOSURE OF THE PRESENT INVENTION

The present invention was made in view of the foregoing circumstances and it is an object of the present invention to improve connection reliability.

### Means for Solving the Problem

A lighting device of the present invention includes a light source having an external connecting portion at an end part; a chassis housing the light source; and a connector mounted to the chassis and including an insertion path to which the external connecting portion is inserted, a connection terminal configured to expand to receive the external connecting portion inserted to the insertion path, and a restricting portion configured to be selectively moved in one of a first position and a second position. The restricting portion positioned in the first position allows the external connecting portion to be inserted to the insertion path and allows the connection terminal to expand to receive the external connecting portion. The restricting portion positioned in the second position restricts the external connecting portion to be inserted to the insertion path and restricts expansion of the connection terminal that holds the external connecting portion therein.

With this configuration, if the restricting portion is arranged in the first position, the external connecting portion at an end part of the light source is allowed to be inserted to the insertion path of the connector and the connection terminal sandwiching the external connecting portion is allowed to expand. Therefore, the external connecting portion is inserted from the outside into the insertion path and the connection terminal sandwich the external connection portion therebetween. Also, the external connecting portion is detached from the connection terminal and removed to the outside to the insertion path. If the restricting portion is positioned in the second position after the external connecting portion is sandwiched with the connection terminal, insertion of the external connecting portion into the insertion path is restricted and expansion of the connection terminal sandwiching the external connecting portion is restricted. Accordingly, even if vibration or impact is applied to the lightning device from the outside, it is prevented that the connection terminal is carelessly expanded and the sandwiched external connecting portion is detached therefrom or the detached external connecting portion falls out to the outside through the insertion path. The restricting portion positioned in the second position directly operates to the external connecting portion and the connection terminal that are mutually connected and this prevents a connection state from being released. Therefore, it is possible to maintain the connection state between the external connecting portion and the connection terminal more stably than the conventional structure and acquire higher connection reliability.

As embodiments of the present invention, the following configurations are preferable.

(1) The connector may include a connector housing mounted to the chassis and configured to house the connection terminal, and the restricting portion may be provided separately from the connector housing. With this structure, compared to a case where the restricting portion is integrally provided to the connector housing, the restricting portion is freely designed.

(2) The restricting portion may move approximately linearly between the first position and the second position. With this configuration, the restricting portion is approximately linearly moved between the first position and the second position, and this improves workability. The restricting portion is formed separately from the connector housing, and this easily achieves a design for approximately linear movement.

(3) The restricting portion may move in a movement direction that is inclined to an insertion direction in which the external connecting portion is inserted to the insertion path. With this configuration, compared to a case where the movement direction of the restricting portion is orthogonal to the insertion direction of the external connecting portion, the restricting portion is easier to be operated when moving, and this improves workability.

(4) At least one of the restricting portion and the connector housing may have a guide surface that is inclined to the insertion direction in which the external connecting portion is inserted to the insertion path and guide movement of the restricting portion. With this configuration, the restricting portion is operated along the insertion direction of the external connecting portion with respect to the insertion path, and accordingly, the movement of the restricting portion is guided by the guide surface. That is, an operation of inserting the external connecting portion into the insertion path and connecting it to the connection terminal and an operation of moving the restricting portion are executed in the same direction and this improves workability.

(5) The restricting portion may include a pair of restricting pieces. The pair of restricting pieces may be separated from each other and form a space therebetween that is communicated to the insertion path in the first position. The pair of restricting pieces may be closer to each other to narrow the space as the restricting pieces move from the first position to the second position. With this configuration, the space formed between the restricting pieces is communicated to the insertion path in the first position, and therefore, facing surfaces of the restricting pieces determine the position of the external connecting portion with respect to the insertion path. If the restricting pieces are moved from the first position to the second position, the restricting pieces move closer to each other to narrow the space. This restricts insertion of the external connecting portion into the insertion path and expansion of the connection terminal sandwiching the external connecting portion.

(6) The pair of restricting pieces may have a symmetrical shape. With this configuration, each of the restricting pieces is formed from a common component, and this reduces cost for the restricting portion.

(7) The lighting device may further include a holding structure provided on the restricting portion and the connector housing and configured to hold the restricting portion with respect to the connector housing selectively in one of the first position and the second position. With this configuration, it is possible to hold the restricting portion in one of the first position and the second position.

(8) The connector may include a connector housing that is mounted to the chassis and configured to house the connection terminal, and the restricting portion may be integrally formed with the connector housing. With this configuration, compared to a case where the restricting portion is formed separately from the connector housing, the number of components and the production cost are reduced.

(9) The restricting portion may be connected to the connector housing via a hinge and rotatably move around the hinge between the first position and the second position. With this configuration, the restricting portion is moved rotatably around the hinge to be moved between the first position and the second position.

(10) The light source may be formed in a linear shape having an axis. The restricting portion that is positioned in the first position may be arranged in adjacent to and outside of the connector housing in a direction crossing both the axis and an insertion direction in which the external connecting portion is inserted to the insertion path. With this configuration, it is prevented that the restricting portion in the first position and the connector housing are arranged along the axis of the light source. Therefore, the lighting device is reduced in size in an axial direction of the light source.

(11) The restricting portion may have one end side connected to the connector housing by the hinge and another end side separated from the connector housing. With this configuration, in the first position, the restricting portion is arranged adjacent to only one side of the connector housing in a direction crossing the axis and the insertion direction of the external connecting portion with respect to the insertion path. This ensures a space on a side opposite to the restricting portion in the first position.

(12) The restricting portion may include a pair of restricting pieces, and an end part of one of the restricting pieces that is away from another restricting piece in the second position may be connected to the connector housing by the hinge. With this configuration, in the first position, the pair of restricting pieces is arranged in adjacent to and on both sides of the connector housing in a direction crossing the axis and the insertion direction of the external connecting portion with respect to the insertion path. Therefore, it is possible to reduce the spaces ensured on the both sides of the connector housing when the pair of restricting pieces is arranged in the first position.

(13) The light source may include a plurality of light sources and each of the light sources may have a linear shape having an axis and the light sources may be arranged in parallel to each other along a direction crossing the axis and an insertion direction in which the external connecting portion is inserted to the insertion path. The restricting portion in the first position may be arranged in adjacent to and outside of the connector housing along the axis. With this configuration, the restricting portion is not arranged between adjacent light sources in the first position and therefore, the restricting portion is less likely to interfere with the adjacent light sources. In other words, it is possible to freely set intervals between the adjacent light sources regardless of the restricting portion and reduce regulations in optical design of the lighting device.

(14) The connection terminal may include a pair of elastic contact parts that are configured to be elastically in contact with the external connecting portion. With this configuration, if the external connecting portion is sandwiched by the pair of elastic contact parts of the connection terminal, the pair of elastic contact parts elastically contacts the external connecting portion. This maintains good mutual connection state and further enhances connection reliability.

(15) The lighting device may further include an electric power supply board configured to supply drive electric power to the light source and arranged on a side opposite to the light source with respect to the chassis. The connector may electrically relay-connect the electric power supply board and the light source. With this configuration, the electric power supply board and the light source are relay-connected by the connector and this supplies the drive electric power from the electric power supply board to the light source.

(16) The light source may be configured with a cold cathode tube. This achieves a long service life and easily modulates light.

Next, to solve the above problems, a display device of the present technology includes the above-noted lighting device and a display panel that performs display using light from the lighting device.

According to such a display device, the lighting device that supplies light to the display panel has higher connection reliability between the light source and the connector, and therefore it is possible to perform display in a stable manner.

A liquid crystal panel may be used as the display panel. Such a display device may be used as a liquid crystal display device for a display of a television or a personal computer and is specifically suitable for a large screen.

### Advantageous Effect of the Invention

According to an aspect of the present technology, it is possible to improve connection reliability.

### BRIEF DESCRIPTION OF THE DRAWINGS

FIG. 1 is an exploded perspective view showing a schematic configuration of a television receiver according to a first embodiment of the present invention;

FIG. 2 is an exploded perspective view showing a schematic configuration of a liquid crystal display device provided in a television receiver;

FIG. 3 is a cross-sectional view showing a cross-sectional configuration along a long side direction of a liquid crystal display device;

FIG. 4 is a plan view showing an arrangement configuration of a cold cathode tube, a connector and a chassis provided in a liquid crystal display device;

FIG. 5 shows a cross-sectional configuration along a long side direction of a liquid crystal display device and particularly is an enlarged sectional view illustrating a main part of a connector having a restricting portion in a second position;

FIG. 6 is a partial cut-away sectional view of a connector having a restricting portion in the second position;

FIG. 7 is a sectional side view of a connector having a restricting portion in a first position in a state where a cold cathode tube is removed;

FIG. 8 is a partial cut-away sectional view of a connector having a restricting portion in the first position in a state where a cold cathode tube is removed;

FIG. 9 is a partial cut-away sectional view of a connector having a restricting portion according to a second embodiment of the present invention in a second position;

FIG. 10 is a partial cut-away sectional view of a connector having a restricting portion in a first position in a state where a cold cathode tube is removed;

FIG. 11 is a partial cut-away sectional view of a connector having a restricting portion according to a third embodiment of the present invention in a second position;

FIG. 12 is a partial cut-away sectional view of a connector having a restricting portion in a first position in a state where a cold cathode tube is removed;

FIG. 13 is a sectional side view of a connector having a restricting portion according to a fourth embodiment of the present invention in a second position;

FIG. 14 is a partial cut-away sectional view of a connector having a restricting portion in the second position;

FIG. 15 is a sectional side view of a connector having a restricting portion in a first position in a state where a cold cathode tube is removed;

FIG. 16 is a partial cut-away sectional view of a connector having a restricting portion according to a reference example in a first position; and

FIG. 17 is a sectional side view of a connector having a restricting portion in the first position in a state where a cold cathode tube is removed.

### BEST MODE FOR CARRYING OUT THE INVENTION

### First Embodiment

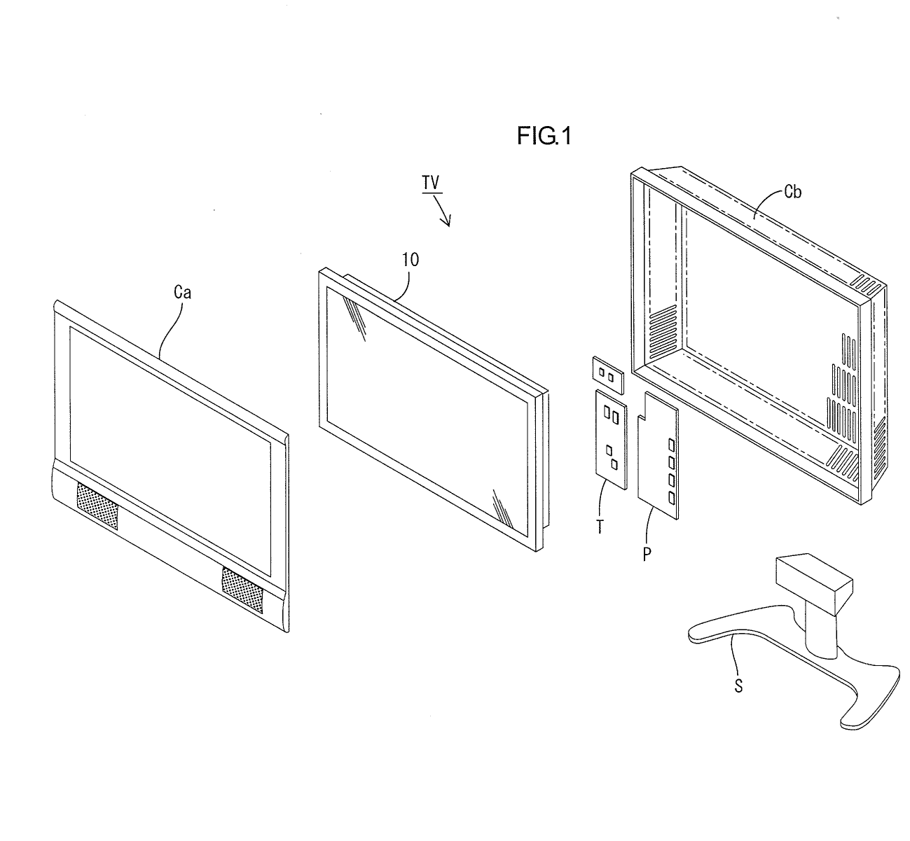

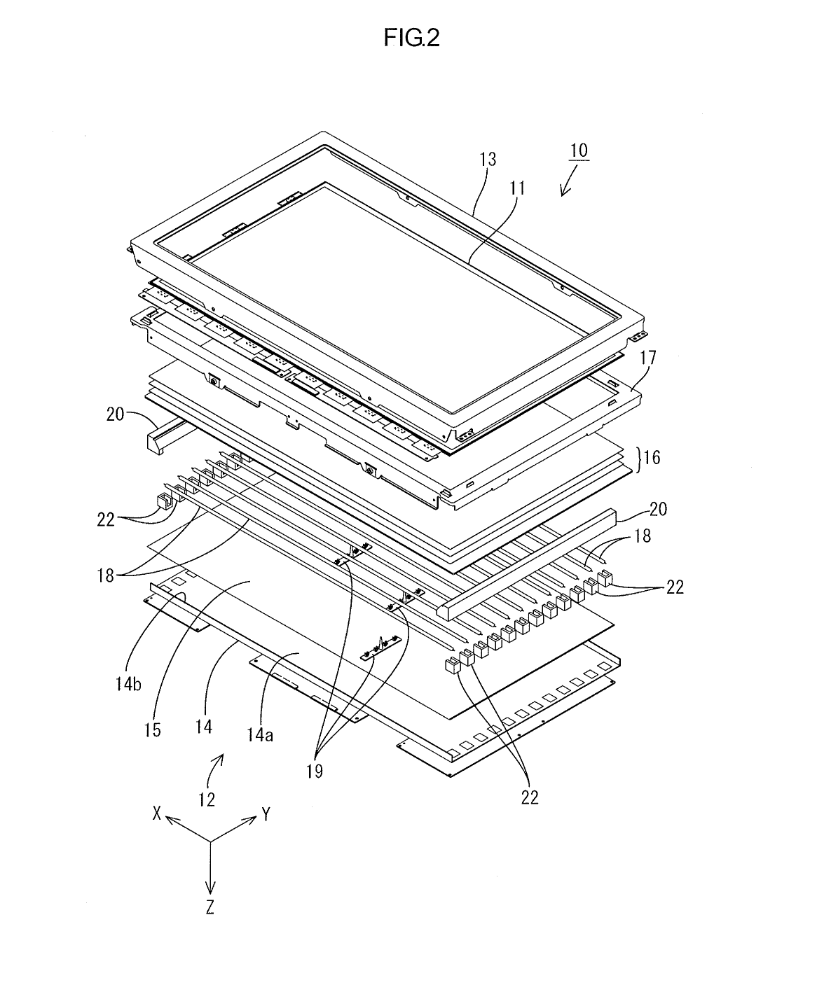

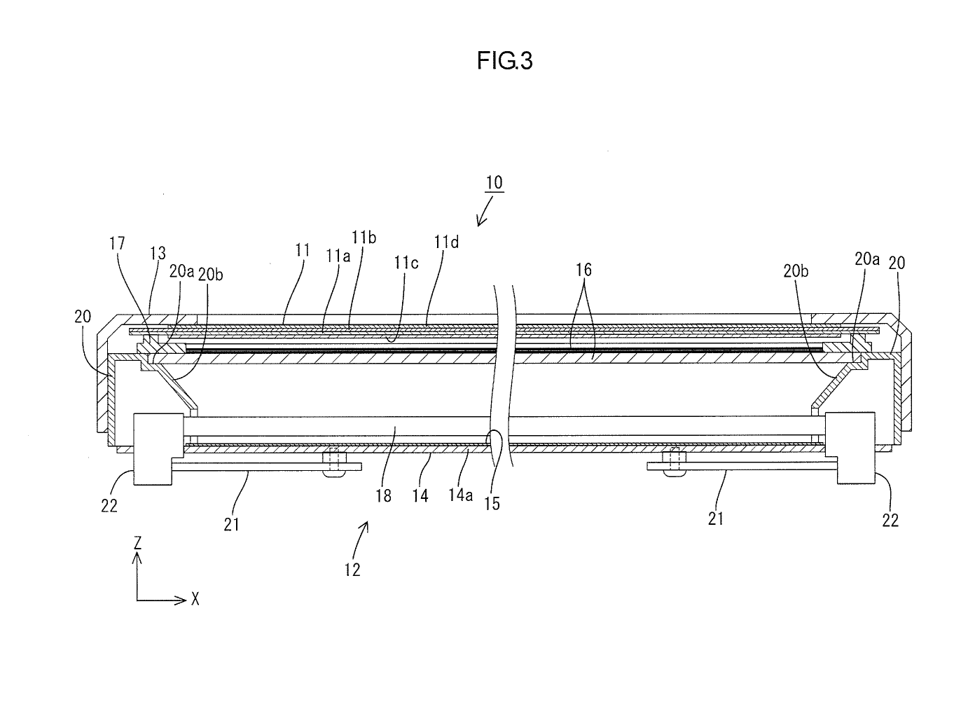

The first embodiment of the present invention will be explained using FIGS. 1 to 8. In the present embodiment, a liquid crystal display device 10 will be exemplified. Here, part of the figures includes the X axis, the Y axis and/or the Z axis, and is depicted such that each axis direction shows the direction in each figure. It is also assumed that the upper side of FIGS. 2 and 3 is the front side and the lower side of these figures is the rear side.

As illustrated in FIG. 1, a television receiver TV according to the present embodiment is configured with the liquid crystal display device 10 (display device), front and rear cabinets Ca and Cb housing the liquid crystal display device 10 in a sandwiching manner, a power source P, a tuner T and a stand S. The liquid crystal display device 10 has a horizontally-long square shape as a whole and, as illustrated in FIG. 2, has a liquid crystal panel 11 serving as a display panel and a backlight unit 12 (lighting device) serving as an external light source. These are integrally held by, for example, a frame-shaped bezel 13.

Next, the liquid crystal panel 11 and the backlight unit 12 forming the liquid crystal display device 10 will be explained sequentially. The liquid crystal panel 11 has a rectangular shape in a plan view, and, as illustrated in FIG. 3, a pair of glass substrates 11a and 11b is bonded across a predetermined gap and a liquid crystal layer (not illustrated) is sealed between the both glass substrates 11a and 11b. One glass substrate 11a is provided with a switching component (e.g. TFT) connected to a source wiring and a gate wiring that are orthogonal to each other, a pixel electrode connected to the switching component, and further an alignment film or the like. The other glass substrate 11b is provided with a color filter in which color sections such as R (red), G (green) and B (blue) are arranged in a predetermined alignment; a counter electrode; and further an alignment film or the like. Among these, for the source wiring, the gate wiring, the counter electrode or the like, image data required to display an image and various control signals are supplied from a drive circuit board (not illustrated). Here, polarizing plates 11c and 11d are arranged in the outsides of the both glass substrates 11a and 11b.

As illustrated in FIGS. 2 and 3, the backlight unit 12 is a so-called direct backlight having a light source arranged immediately below the back surface of the liquid crystal panel 11 and has a chassis 14 having a substantially box shape opened toward the front side (the light output side or the side of liquid crystal panel 11), a reflection sheet 15 installed in the chassis 14, a plurality of optical members 16 arranged so as to cover the opening 14b of the chassis 14, a frame 17 that can hold the optical members 16, a plurality of cold cathode tubes 18 (light sources) housed in parallel to each other in the chassis 14, a lamp clip 19 holding the central side part of the cold cathode tubes 18, and a lamp holder 20 that blocks light at the end parts of the cold cathode tubes 18 and that has light reflectivity. Further, this backlight unit 12 has an inverter board 21 (electric power supply board) arranged on the rear side of the chassis 14 (i.e. on the side opposite to the cold cathode tubes 18); and a connector 22 to electrically relay-connect between the inverter board 21 and the cold cathode tubes 18.

The chassis 14 is made from metal such as aluminum and has a configuration in which side plates rise from circumference ends of a bottom plate 14a having a rectangular shape in a plan view similarly to the liquid crystal panel 11. The long side direction of this bottom plate 14a matches the X-axis direction of each figure and the short side direction matches the Y-axis direction. This bottom plate 14a is arranged on the rear side of the cold cathode tubes 18 so as to face each other; in other words, it is arranged on the side opposite to the light output side in the cold cathode tubes 18. The reflection sheet 15 is made from a white synthetic resin of higher light reflectivity and installed so as to cover the substantially whole area of the inner surface in the bottom plate 14a of the chassis 14, and has a function of reflecting light from the cold cathode tubes 18 to the side of the optical member 16 (light output side).

The optical member 16 has a rectangular shape in a plan view similarly to the bottom plate 14a of the chassis 14 and the liquid crystal panel 11, and is made from a synthetic resin capable of light transmission and provided between the cold cathode tubes 18 on the rear side and the liquid crystal panel 11 on the front side. The optical member 16 is configured with, for example, a diffuser plate, a diffuser sheet, a lens sheet and a brightness enhancement sheet in this order from the rear side, and has a function of converting light emitted from each of the cold cathode tubes 18 serving as linear light sources, into uniform planar light.

The frame 17 has a frame shape along a marginal part of the liquid crystal panel 11 or the optical member 16. The frame 17 is arranged on the front side of the optical member 16 and can sandwich the marginal part of the optical member 16 between the side plates of the chassis 14 and the lamp holder 20 which will be described later. Also, the frame 17 can hold the liquid crystal panel 11 from the rear side and sandwich the liquid crystal panel 11 with the bezel 13 arranged on the front side of the liquid crystal panel 11.

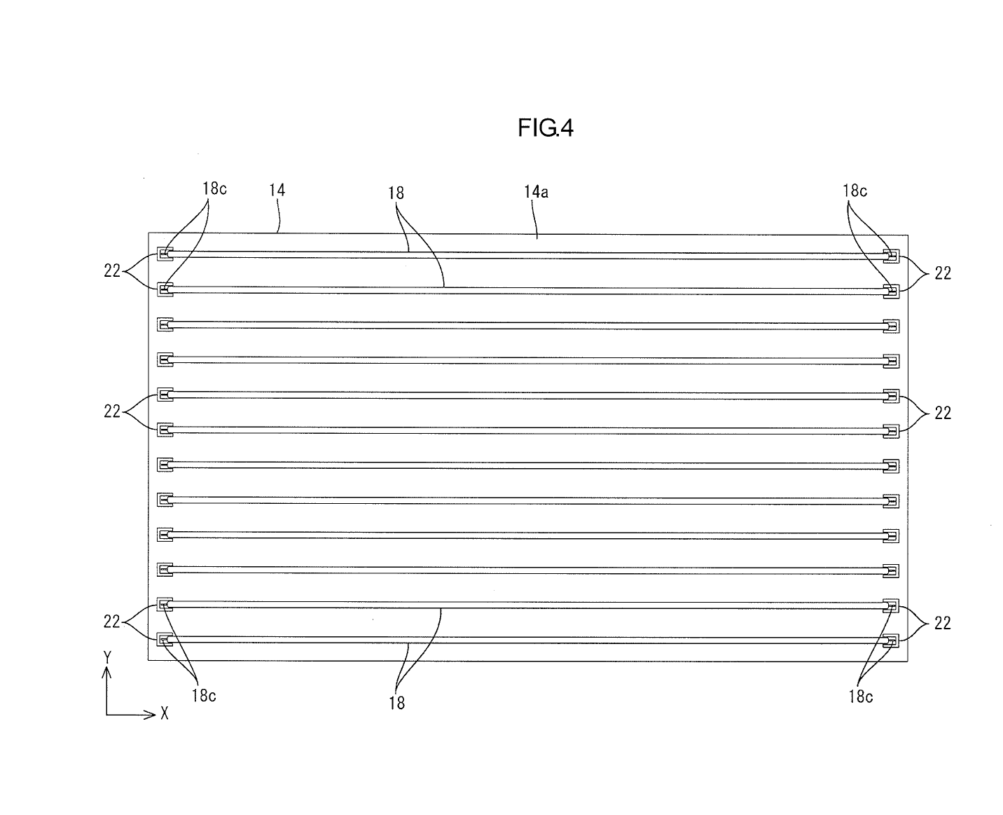

The cold cathode tubes 18 are a kind of linear light sources (tubular light sources). As illustrated in FIG. 4, they are housed in the chassis 14 in a state where their axis direction matches the long side direction (X-axis direction) of the chassis 14, and they are arranged in parallel to each other along the short side direction (Y-axis direction) of the chassis 14 in a state where their axes are substantially parallel to each other with predetermined intervals. Accordingly, both end parts of each of the cold cathode tubes 18 are arranged in parallel to each other along the short side direction in both end parts in the long side direction of the chassis 14. It is presumed that an interval between the cold cathode tubes 18 adjacent to each other, that is, an arrangement pitch is substantially identical.

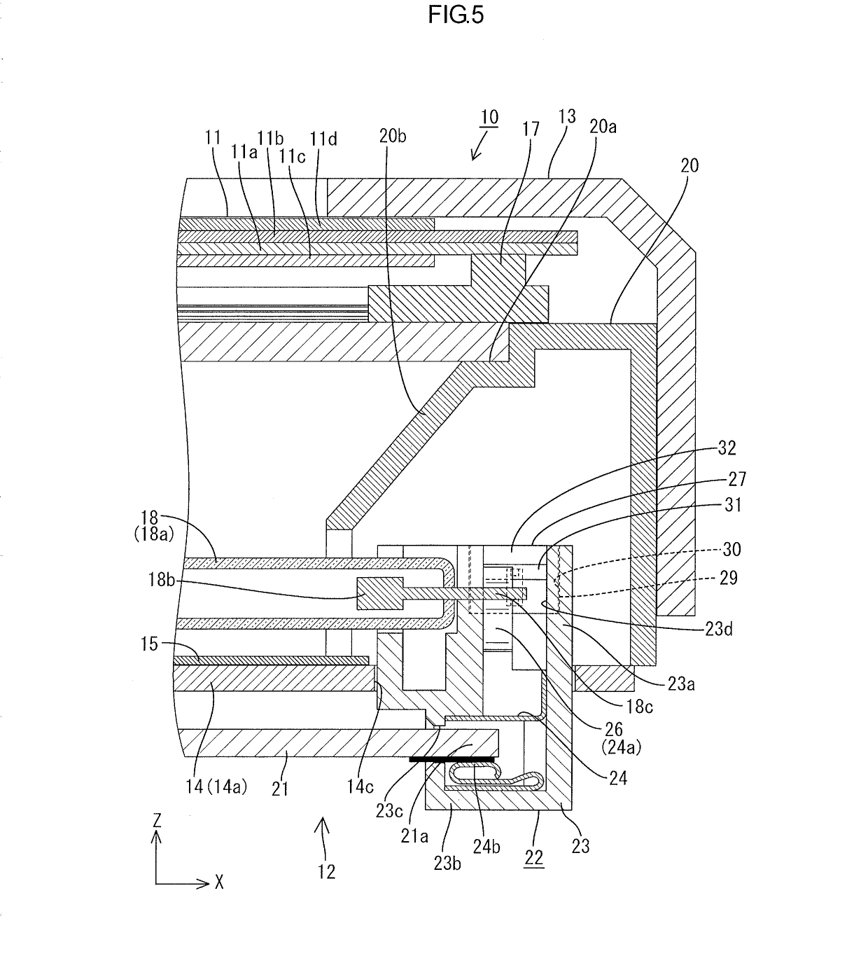

These cold cathode tubes 18 are a kind of discharge tubes and, as illustrated in FIG. 5, have a long and thin glass tube 18a having a circular shape in cross-section in which both end parts are sealed, a pair of electrode portions 18b sealed inside the both end parts of the glass tube 18a, and a pair of outer leads 18c extending from the both end parts of the glass tube 18a to the outside. These cold cathode tubes 18 are a so-called straight tube type in which the glass tube 18a has a straight line shape and the electrode portions 18b are arranged in two directions (the right direction and the left direction illustrated in FIGS. 3 and 4) in a distributed manner. The glass tube 18a is sealed with, for example, mercury that is a luminous material, and a phosphor (this and mercury are not illustrated) is applied to the inner wall surface. Both the electrode portions 18b and the outer lead 18c are made from metal materials having conductive property, and, among these, the electrode portions 18b are preferably made from alloy of higher sputter resistance. The electrode portions 18b have a substantially cup shape and are housed in the end part of the glass tube 18a. The outer lead 18c has a substantially long thin columnar shape that penetrates the seal end fringe of the glass tube 18a and extends to the outside along the axis direction of the glass tube 18a (X-axis direction or length direction), and, since its inner end part is connected to the electrode portions 18b inside the glass tube 18a, the same electric potential as that of the electrode portions 18b is applied.

The lamp clip 19 is made from a white synthetic resin of high light reflectivity and, as illustrated in FIG. 2, distributed and arranged in a predetermined distribution on the inner surface in the bottom plate 14a of the chassis 14. The lamp clip 19 is fixed to the bottom plate 14a of the chassis 14 and can hold the central side part excluding the both end parts of each of the cold cathode tubes 18. Accordingly, it is possible to maintain the interval between the cold cathode tubes 18 and the bottom plate 14a of the chassis 14.

The lamp holder 20 is made from a white synthetic resin of high light reflectivity and, as illustrated in FIGS. 2 and 3, extends along the short side direction of the chassis 14 and has a substantially box shape in which the rear side surface is opened. A pair of the lamp holder 20 is attached to both end parts in the long side direction of the chassis 14 so as to collectively cover the end part of each of the cold cathode tubes 18 arranged in parallel to each other therein. On the front side surfaces of these lamp holders 20, as illustrated in FIG. 3, although a stage portion is formed, it is an optical member placement portion 20a on which the optical member 16 can be placed. Also, the lamp holders 20 have a slope portion 20b inclined from the optical member placement portion 20a to the bottom plate 14a of the chassis 14.

The inverter board 21 is made by forming a predetermined circuit pattern on a board made from a synthetic resin (made from, for example, a phenolic paper or a glass-epoxy resin) and mounting various electrical components (these and the circuit pattern are not illustrated) such as a transformer. This inverter board 21 is connected to the power source P of the liquid crystal display device 10 and has a function of controlling the lighting and extinction of the cold cathode tubes 18 by rising the pressure of an input voltage that is input from the power source P and by, for example, outputting an output voltage higher than the input voltage to the cold cathode tubes 18. As illustrated in FIG. 3, a pair of the inverter boards 21 is attached by a pair of screws to both end portions in the long side direction in the rear side surface of the bottom plate 14a of the chassis 14 (the surface on the side opposite to an installation surface of the cold cathode tubes 18). In the end part of the inverter board 21, a connector connecting portion 21a that is individually connected in a fitted manner to the connector 22 which will be described next is formed.

As illustrated in FIGS. 3 and 4, a pair of the connectors 22 is arranged in positions corresponding to both end parts of the cold cathode tubes 18 with respect to the chassis 14, that is, in both end positions in the long side direction in the bottom plate 14a, and a plurality of the connectors 22 (corresponding to the number of the cold cathode tubes 18) is arranged along the short side direction of the bottom plate 14a (Y-axis direction or parallel direction of the cold cathode tubes 18). The arrangement pitch of the connectors 22 is substantially equal to the arrangement pitch of the cold cathode tubes 18. Installation positions in the Y-axis direction of the connectors 22 are aligned so as to be substantially equal to those of the cold cathode tubes 18. Also, in the installation positions of the connectors 22 in the bottom plate 14a of the chassis 14, a plurality of attachment holes 14c that can attach the connectors 22 is arranged in parallel to each other along the Y-axis direction.

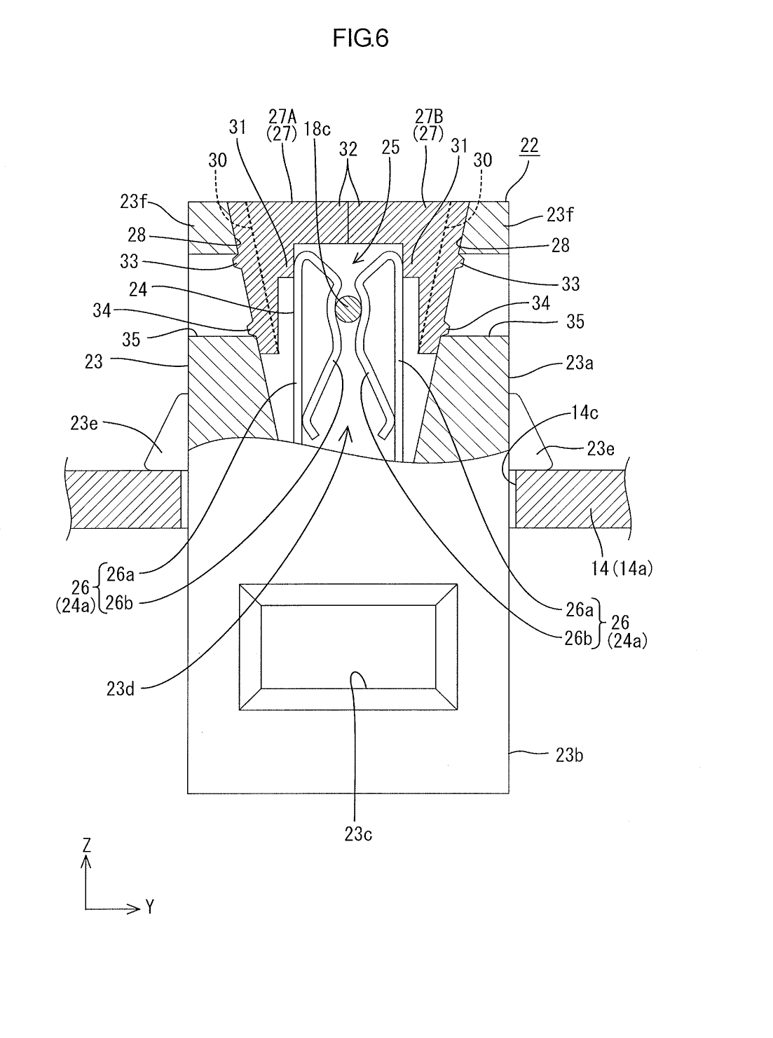

As illustrated in FIG. 5, the connector 22 is configured with a connector housing 23 that is made from a synthetic resin having insulation properties and that has a substantially block shape as a whole and with a connection terminal 24 housed in the connector housing 23. The connector 22 is mounted to the chassis 14 so as to penetrate the bottom. plate 14a of the chassis 14. Apart of the connector housing 23 arranged inside the chassis 14 is a light source receiving portion 23a that receives the end part (including the outer lead 18c) of the cold cathode tube 18. A part of the connector housing 23 arranged outside the chassis 14 is a board receiving portion 23b that receives the connector connecting portion 21a of the inverter board 21. In the light receiving portion 23a, an arc-like groove portion similar to the outline of the end portion of the cold cathode tube 18 is formed to receive the end portion of the cold cathode tube 18. In the board receiving portion 23b, a board insertion opening 23c opened toward the side of the inverter board 21 is provided along the X-axis direction. Besides, in the connector housing 23, a terminal housing room 23d that can house the connection terminal 24 is formed. The terminal housing room 23d is formed with ranging from the light source receiving portion 23a to the board receiving portion 23b, and has an insertion path 25 to which the outer lead 18c of the cold cathode tube 18 is inserted, and is communicated with the board insertion opening 23c in the board receiving portion 23b. The insertion path 25 is opened toward the front side in the light source receiving portion 23a and therefore the outer lead 18c is put in or put out of the connector 22. Also, as illustrated in FIG. 6, a holding projection 23e is provided on an external surface of the light source receiving portion 23a. The holding projection 23e is stepped by the marginal part of the attachment hole 14c to hold the connector 22 so as not to be disengaged therefrom. Also, the insertion direction of the outer lead 18c matches the Z-axis direction.

The connection terminal 24 has a size so as to be housed in the terminal housing room 23d and range from the light source receiving portion 23a to the board receiving portion 23b. In the connection terminal 24, an end part arranged inside the above light source receiving portion 23a is a light source contact portion 24a that can contact the outer lead 18c of the cold cathode tube 18, and an end part arranged inside the above board receiving portion 23b is a board contact portion 24b that can contact the connecter connecting portion 21a in the inverter board 21. An output voltage that is output from the inverter board 21 can be input to the outer lead 18c and the electrode portions 18b of the cold cathode tube 18 via the connection terminal 24 of the connector 22. Among these, the board contact portion 24b has one spring portion and comes into elastic contact with the contact connecting portion 21a. The insertion and extraction direction of the connector connecting portion 21a with respect to the board contact portion 24b substantially matches the X-axis direction.

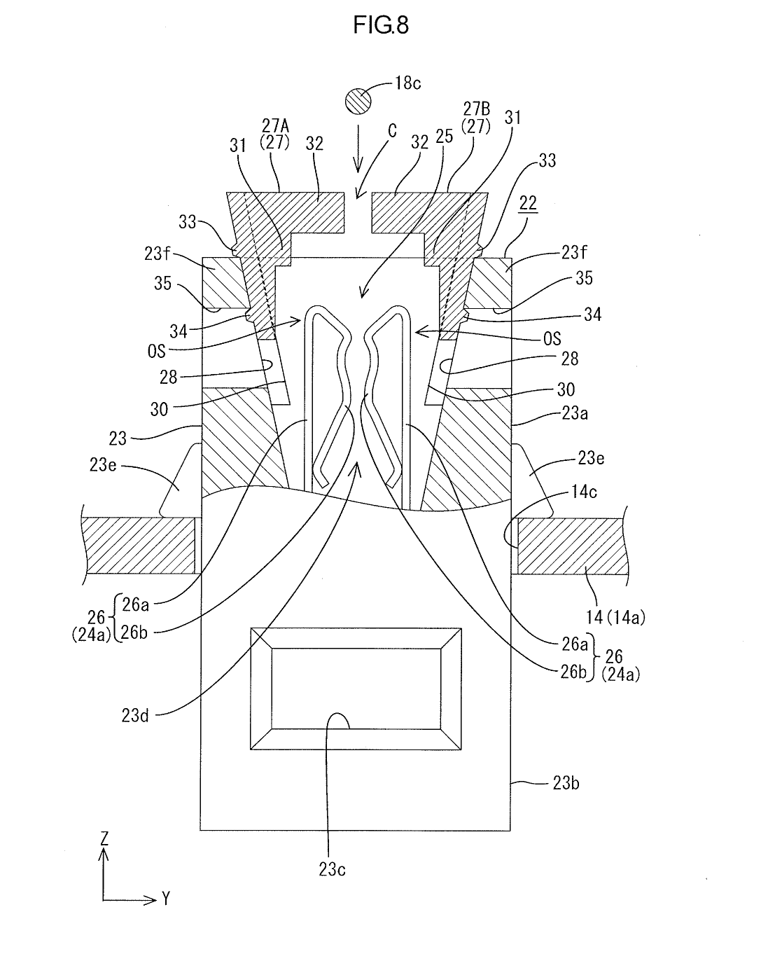

As illustrated in FIG. 6, the light source contact portion 24a has a pair of elastic contact parts 26 that sandwich the outer lead 18c and come into elastic contact with it. The pair of elastic contact parts 26 is arranged so as to face each other in the Y-axis direction and sandwiches and holds the outer lead 18c in an elastic manner. The outer lead 18c is inserted to and extracted from the pair of elastic contact parts 26 in the Z-axis direction, and at the time of insertion or extraction, the outer lead 18c passes through the insertion path 25 in the terminal housing room 24d. The elastic contact part 26 is configured with a base portion 26a and a fold portion 26b internally folded from an end part on the front side in the base portion 26a (the near side in the insertion direction of the outer lead 18c) to the rear side (the far side in the insertion direction of the outer lead 18c), and the distal end part of the fold portion 26b contacts with the base portion 26a. That is, both ends of the fold portion 26b are supported by the base portion 26a. The pair of elastic contact parts 26 are opened or closed and elastically deformed according to insertion or extraction of the outer lead 18c. At the time of elastic deformation, the elastic contact parts 26 are displaced in the Y-axis direction with the root position of the base portion 26a provided as a supporting point, and, at the time of expansion, they are displaced toward the outside in the Y-axis direction, that is, to a side opposite to the outer lead 18c side. When the elastic contact parts 26 are in a closed state, a space is generated outside of the elastic contact parts 26 in the Y-axis direction in the terminal housing state 23d. The space is an expansion allowance space OS that allows the expansion of the elastic contact parts 26 (FIG. 8). Also, the elastic contact parts 26 can be displaced with the fold base end position or fold distal end position of the fold portion 26b provided as a supporting point at the time of elastic deformation.

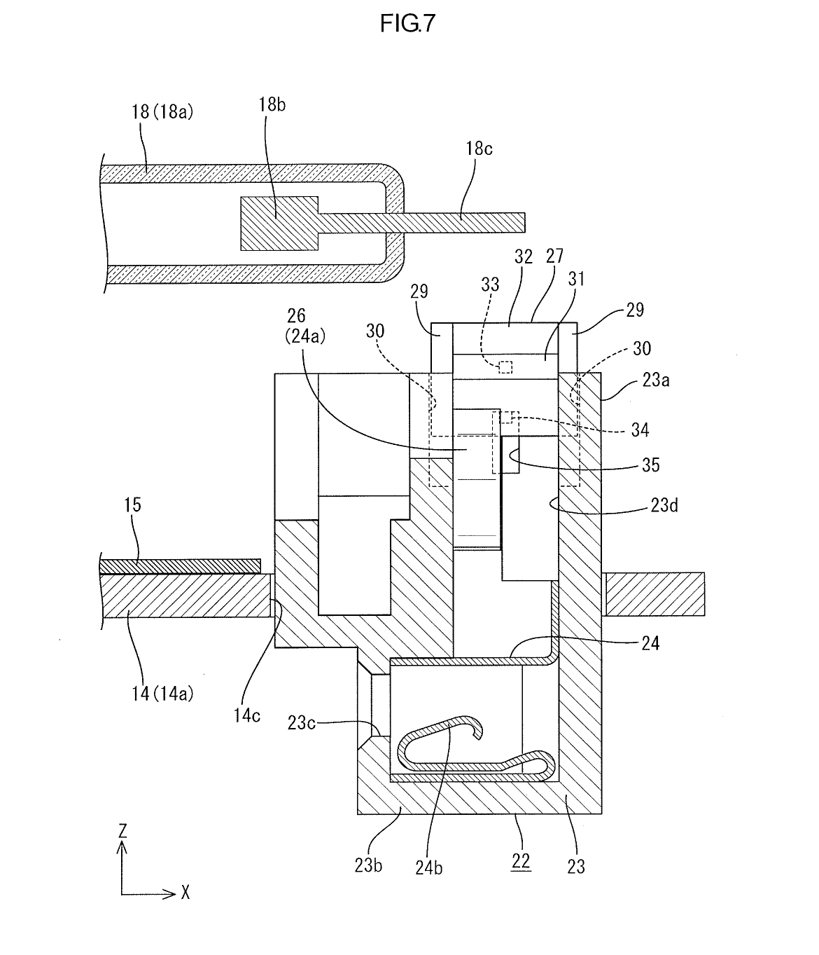

The connector 22 according to the present embodiment includes a restricting portion 27 to maintain a connection state between the outer lead 18c and the connection terminal 24. The restricting portion 27 is formed separately from the connector housing 23 and is mounted to the terminal housing room 23d of the light source receiving portion 23a. Further, in the connector housing 23, the restricting portion 27 is selectively arranged in one of a first position illustrated in FIGS. 7 and 8 and a second position illustrated in FIGS. 5 and 6. The restricting portion 27 positioned in the first position allows an insertion of the outer lead 18c to the insertion path 25 and allows an expansion of the both elastic contact parts 26 of the connection terminal 24. The restricting portion 27 in the second position restricts an insertion of the outer lead 18c to the insertion path 25 and restricts an expansion of the both elastic contact parts 26 of the connection terminal 24.

To be more specific, the restricting portion 27 has an outline similar to the terminal housing room 23d in the light source receiving portion 23a as a whole. The restriction portion 27 is configured with a pair of restricting pieces 27A and 27B that is mutually divided and has a mutually symmetrical shape. That is, the pair of restricting pieces 27A and 27B is an identical component. In an inner periphery of the terminal housing room 23d, both internal surfaces in the X-axis direction have a substantially straight shape along the Z-axis direction as illustrated in FIG. 5, and both internal surfaces in the Y-axis direction (open and close direction of the pair of elastic contact parts 26) have a slope shape in the Z-axis direction (insertion and extraction direction of the outer lead 18c) as illustrated in FIG. 6, and these are guide surfaces 28 that guide the movement of the restricting pieces 27A and 27B. The pair of guide surfaces 28 has a gradient such that an interval therebetween in the Y-axis direction becomes wider as it is closer to the front side (front surface side) in the insertion direction of the outer lead 18c in the terminal housing room 23d and the interval becomes narrower as it is closer to the far side (rear surface side). Therefore, as the pair of restricting pieces 27A and 27B is moved along the pair of guide surfaces 28, the pair of restricting pieces 27A and 27B is relatively displaced so as to be close to or away from each other in the Y-axis direction. Also, each of the surfaces of the restricting pieces 27A and 27B that face the guide surfaces 28 is a slope surface of the same gradient. Further, as illustrated in FIGS. 5 and 7, a pair of guide protrusions 29 projecting outward is formed in both end parts in the X-axis direction in the restricting pieces 27A and 27B, and a pair of guide groove portions 30 that receives each of the guide protrusions 29 is concave-formed in both internal surfaces in the X-axis direction in the terminal housing room 23d. The facing surfaces of the guide protrusions 29 and the guide groove portions 30 are parallel to the guide surfaces 28. By the guide surfaces 28, the guide protrusions 29 and the guide groove portions 30, the restricting pieces 27A and 27B are guided to move approximately linearly along a direction inclined to the Z-axis direction that is the insertion and extraction direction of the outer lead 18c with respect to the connector housing 23.

As illustrated in FIG. 6, the pair of restricting pieces 27A and 27B has an expansion restricting portion 31 that restricts expansion of the elastic contact parts 26 and an insertion restricting portion 32 that restricts insertion of the outer lead 18c to the insertion path 25. The expansion restricting portion 31 is arranged in substantially a middle portion of the restricting pieces 27A and 27B in the Z-axis direction and projects inward, and its outline is a substantially straight shape along the Z-axis direction similarly to the outline in the base portion 26a of the elastic contact part 26. The insertion restricting portion 32 is arranged in the front-side end portion in the Z-axis direction in the restricting pieces 27A and 27B and projects inward more largely than the expansion restricting portion 31.

When the pair of restricting pieces 27A and 27B is arranged in the first position illustrated in FIGS. 7 and 8, part of them (including the insertion restricting portion 32) projects from the connector housing 23 to the front side and a gap C is formed between the insertion restricting portions 32 that face each other so as to extend in the Y-axis direction. The gap C is communicated with the insertion path 25 of the connector 22 and has substantially the same width as the insertion path 25. Therefore, it is possible to insert the external outer lead 18c into the gap C and sequentially insert it into the insertion path 25 or alternatively insert the outer lead 18c sandwiched between the elastic contact parts 26 into the insertion path 25 and sequentially insert it into the gap C to extract it to the outside. Thus, in the first position, it can be said that the insertion restricting portion 32 evacuates from the insertion path 25 of the connector 22. Also, the outer lead 18c is in contact with and slid along the facing surfaces of the both insertion restricting portions 32 forming the gap C to guide its insertion or extraction operation. In the first position, the expansion restricting portion 31 is arranged in a position away from the elastic contact part 26 of the connection terminal 24 in the Z-axis direction and Y-axis direction and evacuates from an expansion allowance space OS of the elastic contact part 26. This allows the pair of elastic contact parts 26 to be deformed to expand outwardly in the Y-axis direction, and accordingly the outer lead 18c is inserted to and extracted from the connection terminal 24.

When the pair of restricting pieces 27A and 27B is in the second position illustrated in FIGS. 5 and 6, the restricting pieces are entirely housed in the terminal housing room 23d of the connector housing 23. In the second position, the pair of insertion restricting portions 32 enters the insertion path 25 and closes the insertion path 25, and the facing surfaces of the insertion restricting portions 32 are contacted with each other. That is, the gap C formed between the insertion restricting portions 32 in the first position is narrowed and eliminated as the restricting pieces 27A and 27B are moved to the second position. Accordingly, it is almost impossible to insert the outer lead 18c into the insertion path 25. In the second position, the expansion restricting portion 31 is arranged so as to be adjacent to and outside of the base portion 26a of the elastic contact part 26 (on the side opposite to the outer lead 18c) in the Y-axis direction and enters the expansion allowance space OS of the elastic contact part 26. This restricts the pair of elastic contact parts 26 from being deformed to expand outward in the Y-axis direction (direction away from the outer lead 18c). If it is set such that the expansion restricting portion 31 is pressure-contacted inward (on the side of the outer lead 18c) to the elastic contact part 26 in the second position, it is possible to enhance the contact pressure applied to the outer lead 18c sandwiched by the elastic contact parts 26.

The restricting pieces 27A and 27B are selectively held in the first position or the second position with respect to the connector housing 23, and the connector housing 23 and the restricting pieces 27A and 27B have the holding structure that will be explained next. The holding structure is configured with a first holding protrusion 33 and a second holding protrusion 34 that are provided in the restricting pieces 27A and 27B and a holding groove portion 35 provided in the connector housing 23. The first holding protrusion 33 and the second holding protrusion 34 are formed in the facing surfaces of the guide surfaces 28 of the restricting pieces 27A and 27B. The first holding protrusion 33 and the second holding protrusion 34 are arranged with a predetermined interval in the Z-axis direction and the first holding portion 33 is relatively arranged on the front side and the second holding protrusion 34 is relatively arranged on the rear side. The holding groove portion 35 is formed by penetrating a side wall 23f having the guide surface 28 in the terminal housing room. 23d of the connector housing 23 in the Y-axis direction. The dimension of the holding groove portion 35 in the Z-axis direction is substantially equal to the external dimension between the first holding protrusion 33 and the second holding protrusion 34. The dimension in the Z-axis direction of a part remaining on the front side of the holding groove portion 35 in the side wall 23f is substantially equal to the internal dimension smaller than the external dimension between the first holding protrusion 33 and the second holding protrusion 34. Also, if the restricting pieces 27A and 27B are arranged in the first position, as illustrated in FIG. 8, the second holding protrusion 34 is stopped by the marginal part of the holding groove portion 35 on the front side and the first holding protrusion 33 is stopped by the marginal part of the side wall 23f on the front side. Accordingly, the restricting pieces 27A and 27B are held in the first position and prevented from being carelessly displaced to the front side or the rear side in the Z-axis direction from the first position. If the restricting pieces 27A and 27B are arranged in the second position, as illustrated in FIG. 6, the first holding portion 33 is stopped by the marginal part of the holding groove portion 35 on the front side and the second holding protrusion 34 is stopped by the marginal part of the holding groove portion 35 on the rear side. Accordingly, the restricting pieces 27A and 27B are held in the second position and prevented from being carelessly displaced to the front side or the rear side in the Z-axis direction from the second position.

The present embodiment provides the configuration described above and its operation will be explained next. To produce the liquid crystal display device 10, the liquid panel 11, the backlight unit 12 and the bezel 13 that are separately manufactured are assembled. In the following, the manufacturing procedure of the backlight unit 12 will be mainly explained.

Before the connector 22 is mounted to the chassis 14, the connection terminal 24 and the restricting portion 27 are attached to the connector housing 23. The connection terminal 24 is housed in the terminal housing room 23d of the connector housing 23, and accordingly the connection terminal 24 is arranged in a range from the light source receiving portion 23a to the board receiving portion 23b. The pair of restricting pieces 27A and 27B forming the restricting portion 27 is housed in the terminal housing room 23d of the light receiving portion 23a. At this time, as illustrated in FIGS. 7 and 8, the pair of restricting pieces 27A and 27B is mounted to be positioned in the first position. In this state, the gap C communicated to the insertion path 25 is formed between the insertion restricting portions 32, and the expansion restricting portions 31 are arranged to have an interval from the elastic contact parts 26 of the connection terminal 24 and the interval is greater than the expansion allowance space OS. That is, the insertion restricting portions 32 and the expansion restricting portions 31 are arranged so as to evacuate from the insertion path 25 and the expansion allowance space OS.

Each of the connectors 22 having the restricting portion 27 that is positioned in the first position as described above is mounted to the chassis 14, and each of the lamp clips 19 is also attached to the chassis 14 and furthermore the reflection sheet 15 is installed in the chassis 14. Next, each of the cold cathode tubes 18 is housed in the chassis 14. If the cold cathode tubes 18 are housed in the chassis 14, each end part of the cold cathode tubes 18 enters the light source receiving portion 23a of the connector housing 23 of each of the connectors 22 along the Z-axis direction. At this time, each of the outer leads 18c passes through the gap C between the insertion restricting portions 32 of the restricting portions 27, and passes through the insertion path 25 and is inserted to a space between the pair of elastic contact parts 26. The pair of elastic contact parts 26 is pressed and expanded outward by the inserted outer leads 18c, and evacuates into the external expansion allowance space OS and is elastically expansion-deformed in the Y-axis direction. Further, if the cold cathode tubes 18 are pressed into the normal depth in the chassis 14, the outer leads 18c are elastically sandwiched between the pair of elastic contact parts 26 with predetermined contact pressure.

After the cold cathode tubes 18 are housed in the chassis 14, the restricting portion 27 is moved from the first position to the second position. If the restricting pieces 27A and 27B in the first position illustrated in FIG. 8 are pressed toward the rear side along the Z-axis direction (i.e. toward the insertion direction of the outer lead 18c), a lock state of the first holding protrusion 33 with respect to the side wall 23f is cancelled and the restricting pieces 27A and 27B are guided by the guide surfaces 28 tilt with respect to the Z-axis direction and moved along the direction tilt with respect to the Z-axis direction. Thus, the operation directions of the cold cathode tubes 18 and the restricting portion 27 are same, and therefore the workability is high. In the process in which the restricting pieces 27A and 27B move from the first position to the second position, the both insertion restricting portions 32 come close to each other in the Y-axis direction with narrowing the gap C therebetween, and this gradually increases an amount of entering portion of the restriction pieces 27A, 27B into the insertion path 25. Further, the expansion restricting portions 31 come closer to the elastic contact parts 26 in the Z-axis direction and Y-axis direction, and this increases an amount of entering portion of the expansion restricting portions 31 into the expansion allowance space OS. If the restricting pieces 27A and 27B reach the second position, as illustrated in FIG. 6, the insertion restricting portions 32 are contacted to each other, the insertion path 25 is blocked from the outside and the expansion restricting portions 31 are inserted into the expansion allowance space OS and arranged adjacent to and outside of the both elastic contact parts 26. Accordingly, the expansion restricting portions 31 entering the expansion allowance space OS restrict the elastic contact parts 26 sandwiching the outer lead 18c from being expansion-deformed outward. Also, the insertion restricting portions 32 entering the insertion path 25 restrict the outer lead 18c sandwiched between the both elastic contact parts 26 from being inserted into the insertion path 25. Also, since the first holding protrusion 33 and the second holding protrusion 34 are stopped by each marginal part of the holding groove portion 35, the restricting pieces 27A and 27B are restricted from being carelessly displaced in the Z-axis direction from the second position and are stably held in a positioning state.

If all the cold cathode tubes 18 are housed, the lamp holders 20 are attached to the end parts of the chassis 14 in the long side direction. After the lamp holders 20 are attached, the connectors 22 and end portions of the cold cathode tubes 18 are housed in the lamp holders 20 (FIG. 5). After the lamp holder 20 is attached, the optical member 16 is next attached so as to cover the opening 14b of the chassis 14 and the marginal part of the optical member 16 is placed on the optical member placement portion 20a of the lamp holder 20. On the rear surface side of the chassis 14, if the connector connecting portion 21a of the inverter board 21 is inserted into the board insertion opening 23c of the board receiving portion 23b of the connector 22, a terminal of the connector connecting portion 21a is contacted to the board contact portion 24b of the connection terminal 24 (FIG. 5). Accordingly, the inverter board 21 is electrically relay-connected to the cold cathode tube 18 via the connector 22. The backlight unit 12 is assembled as described above and the liquid crystal panel 11 and the bezel 13 are mounted to the backlight unit 12 to obtain the liquid crystal display device 10 (FIG. 3).

When the liquid crystal display device 10 produced as above is transported, large vibration or impact may be applied to the liquid crystal display device 10, and in such a case, a connection state between the connection terminal 24 and the outer lead 18c may be adversely affected. According to the present embodiment, the expansion restricting portions 31 of the restricting portion 27 in the second position are located in the expansion allowance space OS of the elastic contact parts 26 of the connection terminal 24 and restrict the expansion of the both elastic contact parts 26. Therefore, the outer lead 18c sandwiched between the both elastic contact parts 26 is prevented from being released therefrom due to vibration or impact. Further, the insertion restricting portions 32 of the restricting portion 27 in the second position are located in the insertion path 25 and block the insertion path 25 from the outside. Accordingly, insertion of the outer lead 18c into the insertion path 25 is almost impossible and the outer lead 18c is prevented from being released outside. If the outer lead 18c is arranged inside the insertion restricting portions 32 in the terminal housing room 23d, it is possible to maintain a contact state with the elastic contact parts 26. Thus, the restricting portion 27 according to the present embodiment directly operates to the elastic contact parts 26 of the connection terminal 24 and the outer lead 18c that are mutually connected to prevent the connection state from being cancelled. Therefore, even if large vibration or impact is applied to the device, the connection state of the connection terminal 24 and the outer lead 18c is stably maintained and high vibration resistance performance and impact resistance performance are obtained. Accordingly, high connection reliability is also obtained.

As explained above, the backlight unit 12 of the present embodiment includes the cold cathode tube 18 (light source) having the outer lead 18c (external connecting portion) at the end part; the chassis 14 housing the cold cathode tube 18; and the connector 22 mounted to the chassis 14. The connector 22 includes the insertion path 25 to which the outer lead 18c is inserted and the connection terminal 24 that sandwiches the outer lead 18c passing through the insertion path 25. The connector includes the restricting portion 27 that is selectively arranged in one of the first position and the second position. The restricting portion 27 in the first position allows insertion of the outer lead 18c into the insertion path 25 and allows expansion of the connection terminal 24 sandwiching the outer lead 18c. The restricting portion 27 in the second position restricts insertion of the outer lead 18c into the insertion path 25 and restricts expansion of the connection terminal 24 sandwiching the outer lead 18c.

With this configuration, if the restricting portion 27 is arranged in the first position, the outer lead 18c provided at the end part of the cold cathode tube 18 is allowed to be inserted into the insertion path 25 of the connector 22 and the connection terminal 24 sandwiching the outer lead 18c is allowed to be expanded. Therefore, it is possible to insert the outer lead 18c into the insertion path 25 from the outside and sandwich it with the connection terminal 24, and also it is possible to detach the outer lead 18c from the connection terminal 24 and extract it to the outside with passing through the insertion path 25. If the restricting portion 27 is arranged in the second position after the outer lead 18c is sandwiched by the connection terminal 24, insertion of the outer lead 18c into the insertion path 25 is restricted and expansion of the connection terminal 24 sandwiching the outer lead 18c is restricted. Accordingly, for example, even if vibration or impact is applied to the backlight unit 12 from the outside, it is prevented that the connection terminal 24 is carelessly expanded and the sandwiched outer lead 18c is released therefrom or the released outer lead 18c comes out to the outside through the insertion path 25. That is, the restricting portion 27 arranged in the second position directly operates to the outer lead 18c and the connection terminal 24 that are mutually connected and this prevents a connection state from being cancelled. This maintains the connection state between the outer lead 18c and the connection terminal 24 more stably than the related art and higher connection reliability is obtained.

Also, the connector 22 is mounted to the chassis 14 and has the connector housing 23 housing the connection terminal 24, and the restricting portion 27 is formed separately from the connector housing 23. With this configuration, compared to a configuration in which the restricting portion is formed integrally with the connector housing 23, the restricting portion 27 is freely designed.

Also, the restricting portion 27 is approximately linearly moved between the first position and the second position. With this configuration, the restricting portion 27 is moved substantially linearly between the first position and the second position, and this improves workability. The restricting portion 27 is formed separately from the connector housing 23 and this easily achieves design for substantial linear movement.

Also, the movement direction of the restricting portion 27 is inclined to the insertion direction (Z-axis direction) of the outer lead 18c with respect to the insertion path 25. With this configuration, compared to a configuration in which the movement direction of the restricting portion is orthogonal to the insertion direction of the outer lead 18c, the restricting portion 27 is easier to be operated upon movement and the workability is high.

Also, at least one of the restricting portion 27 and the connector housing 23 is provided with the guide surface 28 that is inclined to the insertion direction of the outer lead 18c with respect to the insertion path 25 and guides the movement of the restricting portion 27. With this configuration, the restricting portion 27 is operated along the insertion direction of the outer lead 18c with respect to the insertion path 25, and accordingly the movement of the restricting portion 27 is guided by the guide surface 28. That is, the operation directions are same in an operation of inserting the outer lead 18c into the insertion path 25 and connecting it to the connection terminal 24 and in an operation of moving the restricting portion 27, and this further improves workability.

Also, the restricting portion 27 is formed with the pair of restricting pieces 27A and 27B, and the pair of restricting pieces 27A and 27B is separated from each other and holds the gap C therebetween that is communicated to the insertion path 25 in the first position. The restricting pieces 27A and 27B get closer to each other with narrowing the gap C as they move from the first position to the second position. With this configuration, in the first position, the gap C held between the pair of restricting pieces 27A and 27B is communicated to the insertion path 25, and the facing surfaces of the restricting pieces 27A and 27B determine the position of the outer lead 18c with respect to the insertion path 25. If the pair of restricting pieces 27A and 27B is moved from the first position to the second position, the pair of restricting pieces 27A and 27B get closer to each other with narrowing the gap C. This restricts insertion of the outer lead 18c into the insertion path 25 and expansion of the connection terminal 24 sandwiching the outer lead 18c.

The pair of restricting pieces 27A and 27B has a mutually symmetrical shape. With this configuration, the restricting pieces 27A and 27B are configured with a common component, and this reduces the cost related to the restricting portion 27.

The restricting portion 27 and the connector housing 23 have a holding structure (the first holding protrusion 33, the second holding projection structure 34 and the holding groove 35) that can selectively hold the restricting portion 27 in the first position or the second position with respect to the connector housing 23. With this configuration, it is possible to hold the restricting portion 27 in the first position or the second position in a position determination state.

The connection terminal 24 has the pair of elastic contact parts 26 that comes in elastically contact with the outer lead 18c. With this configuration, if the outer lead 18c is sandwiched between the pair of elastic contact parts 26 of the connection terminal 24, the elastic contact parts 26 elastically contact to the outer lead 18c. This maintains a good mutual connection state and further enhances the connection reliability.

The inverter board 21 that supplies drive electric power to the cold cathode tube 18 (electric power supply board) is arranged on a side of the chassis 14 that is opposite to the cold cathode tube 18 side. The connector 22 electrically relay-connects the inverter board 21 and the cold cathode tube 18 With this configuration, the connector 22 relay-connects the inverter board 21 and the cold cathode tube 18 and this supplies the drive electric power from the inverter board 21 to the cold cathode tube 18.

The light source is configured with the cold cathode tube 18. This achieves a long service life and easily modulates light.

### Second Embodiment

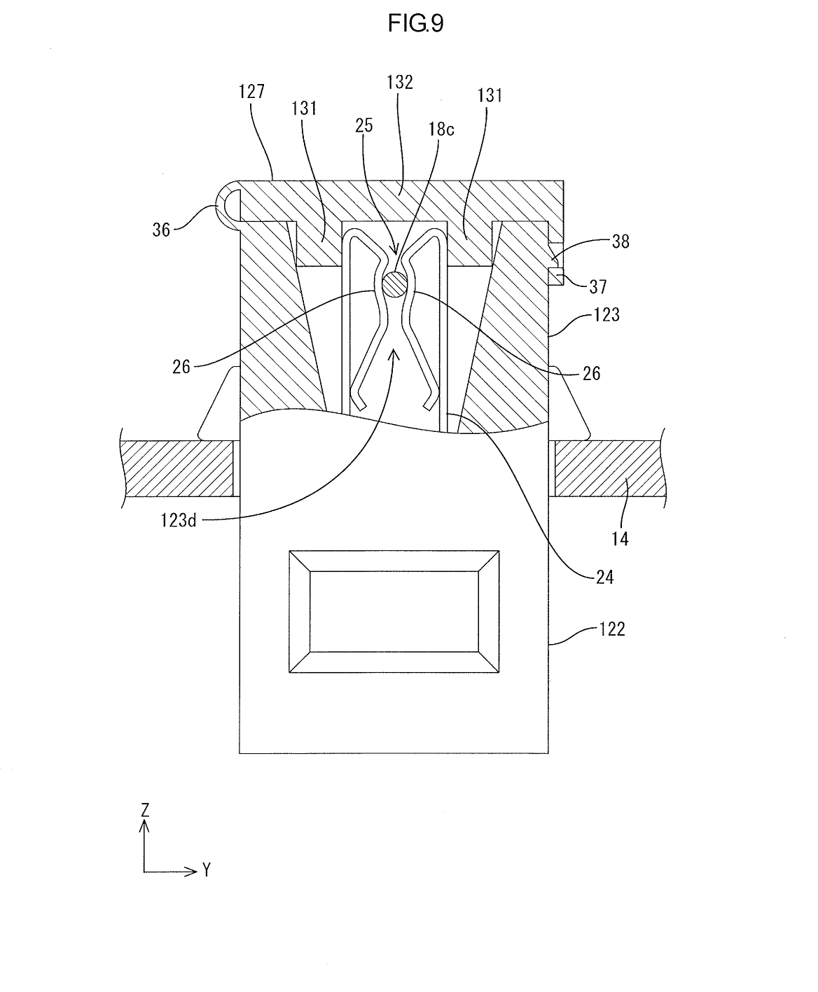

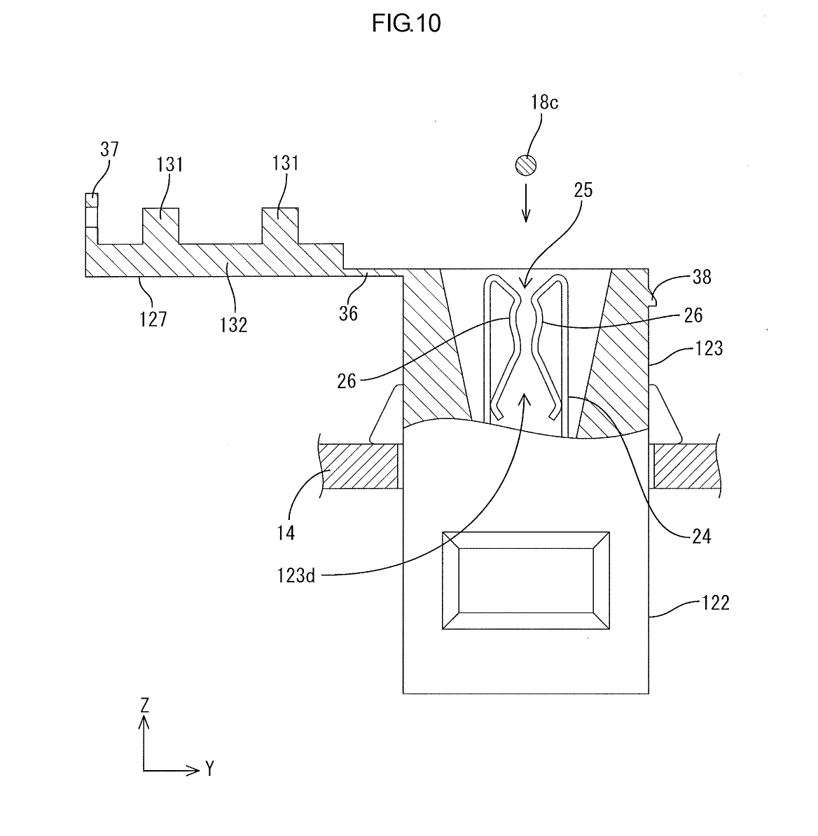

The second embodiment of the present invention will be explained using FIGS. 9 and 10. The second embodiment includes a restricting portion 127 that is different from the restricting portion of the first embodiment. The structure, operation and effects same as those in the first embodiment will not be explained.

As illustrated in FIG. 9, the restricting portion 127 is integrally formed with a connector housing 123. To be more specific, the restricting portion 127 has substantially the same width as that of the connector housing 123 in the Y-axis direction and has a lid shape that closes a terminal housing room 123d. One end part of the restricting portion 127 is connected to the connector housing 123 via a hinge 36, and another end part thereof is separated from the connector housing 123. The hinge 36 connects end parts of the restricting portion 127 and the connector housing 123 in the Y-axis direction. The restricting portion 127 is rotatable around the hinge 36 with respect to the connector housing 123. A position of the restricting portion 127 that closes the terminal housing room 123d and the insertion path 25 as illustrated in FIG. 9 is a second position, and a position of the restricting portion 127 illustrated in FIG. 10 in which the terminal housing room 123d is opened and the restricting portion 127 is arranged adjacent to and outside of the connector housing 123 is a first position. In the first position, as illustrated in FIG. 10, the restricting portion 127 is arranged adjacent to and outside of the connector housing 123 in a direction orthogonal to the Y-axis direction (i.e. the Z-axis direction that is an insertion direction of the outer lead 18c) and to the X-axis direction that is the axis direction of the cold cathode tube 18. That is, the restricting portion 127 in the first position is arranged adjacent to only one side of the connector housing 123 in the Y-axis direction and is not arranged in adjacent to and outside of the connector housing 123 in the X-axis direction. As illustrated in FIG. 9, the middle portion of the restricting portion 127 in the Y-axis direction is an insertion restricting portion 132 that closes the insertion path 25 and restricts an insertion of the outer lead 18c. On the inner surface of the restricting portion 127, a pair of expansion restricting portions 131 is provided in positions away from each other with the same interval as the outer dimension of the pair of elastic contact parts 26 in the Y-axis direction. The other end part of the restricting portion 127 (the end part on the side opposite to the hinge 36 side) is provided with a lock part 37, and the connector housing 123 is provided with a lock protrusion 38 that is fitted to the lock part 37. Accordingly, it is possible to stably hold the restricting portion 127 in the second position.

As described above, according to the present embodiment, a connector 122 is mounted to the chassis 14 and has the connector housing 123 housing the connection terminal 24, and the restricting portion 127 is integrally formed with the connector housing 123. With this configuration, compared to a configuration in which the restricting portion is formed separately from the connector housing 123, and this reduces the number of components and the production cost.

The restricting portion 127 is connected to the connector housing 123 via the hinge 36 and rotates around the hinge 36 between the first position and the second position. With this configuration, the restricting portion 127 is rotated around the hinge 36 to move the restricting portion 127 between the first position and the second position.

The cold cathode tube 18 has a linear shape along the axis direction, and in the first position, the restricting portion 127 arranged adjacent to and outside of the connector housing 123 in a direction (Y-axis direction) crossing the axis direction (X-axis direction) and the insertion direction of the outer lead 18c with respect to the insertion path 25 (Z-axis direction). Accordingly, it is prevented that the restricting portion 127 in the first position and the connector housing 123 are arranged along the axis direction of the cold cathode tube 18 and this reduces a size of the backlight unit 12 in the axis direction of the cold cathode tube 18.

One end side of the restricting portion 127 is connected to the connector housing 123, and the other end side is separated from the connector housing 123. Accordingly, in the first position, the restricting portion 127 is arranged adjacent to only one side of the connector housing 123 in a direction crossing the axis direction and the insertion direction of the outer lead 18c with respect to the insertion path 25, and this ensures the available space on the opposite side.

### Third Embodiment

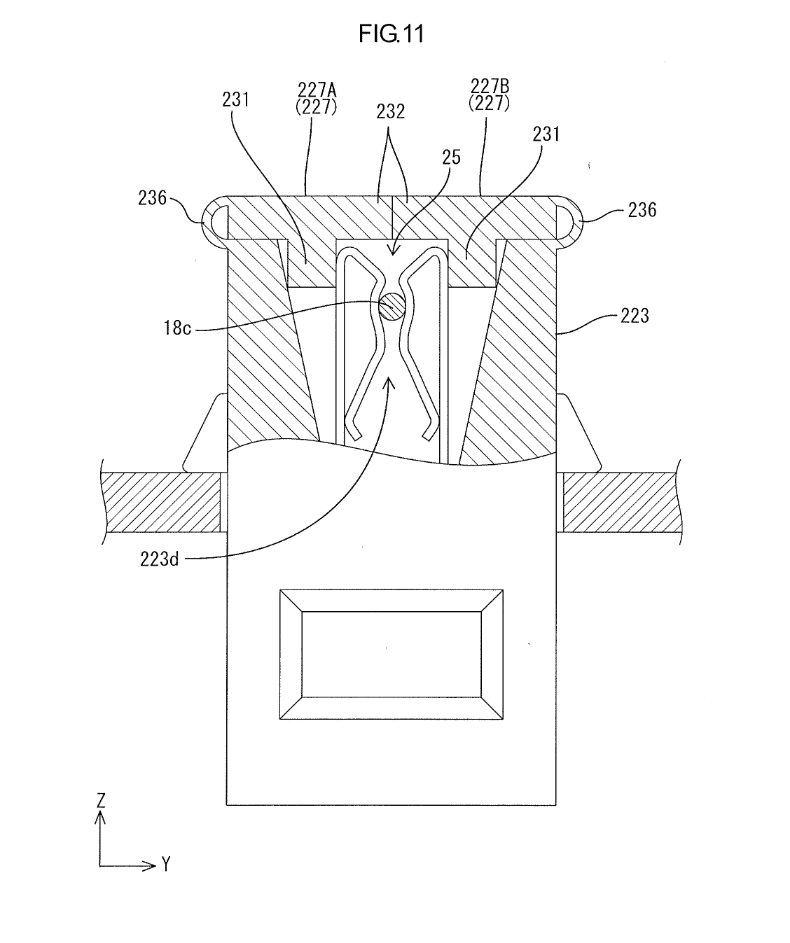

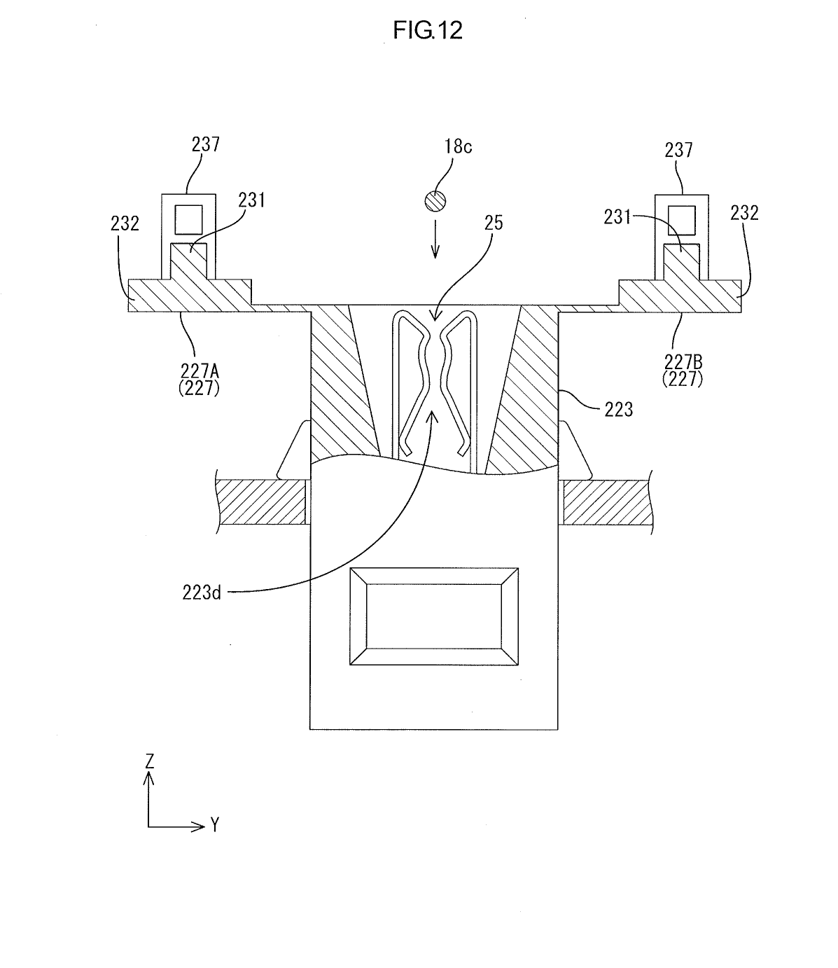

The third embodiment of the present invention will be explained using FIG. 11 or 12. The third embodiment includes a restricting portion 227 that is different from the restricting portion of the second embodiment. Also, the structure, operation and effect same as those in the above second embodiment will not be explained.

As illustrated in FIGS. 11 and 12, the restricting portion 227 is configured with a pair of restricting pieces 227A and 227B. To be more specific, the pair of restricting pieces 227A and 227B has substantially a half size of the connector housing 223 in the Y-axis direction and can block the terminal housing room 223d by cooperating with each other. In a second position illustrated in FIG. 11, outer portions of the pair of restricting pieces 227A and 227B in the Y-axis direction, that is, the end parts of the restricting pieces 227A and 227B that are away from each other are connected to the connector housing 223 by a hinge 236 so as to be rotatable. In the second position of the restricting portions 227A and 227B illustrated in FIG. 11, end parts that face each other are formed separately from the connector housing 223. In a first position illustrated in FIG. 12, each of the restricting pieces 227A and 227B is arranged adjacent to respective external side of the connector housing 223 in the Y-axis direction. As illustrated in FIG. 11, the facing end parts of the restricting pieces 227A and 227B in the second position are insertion restricting portions 232 that block the insertion path 25 and restrict an insertion of the outer lead 18c therein. An expansion restricting portion 231 is provided on an inner surface of each restricting piece 227A, 227B. A lock part 237 similar to the one in the above second embodiment is provided on an end part of each of the restricting pieces 227A and 227B in the X-axis direction, and the lock part 237 is fitted to a lock protrusion (not illustrated) provided in the connector housing 223.

As described above, according to the present embodiment, the restricting portion 227 is configured with the pair of restricting pieces 227A and 227B. The end parts of the restricting pieces 227A and 227B that are away from each other in the second position are connected to the connector housing 223 by the hinge 236. Accordingly, in the first position, the pair of restricting pieces 227A and 227B is arranged adjacent to both sides of the connector housing 223 in a direction (Y-axis direction) crossing the axis direction (X-axis direction) and the insertion direction of the outer lead 18c with respect to the insertion path 25 (Z-axis direction), and this reduces the spaces ensured on the both sides of the connector housing 223 when the pair of restricting pieces 227A and 227B is arranged in the first position.

### Fourth Embodiment

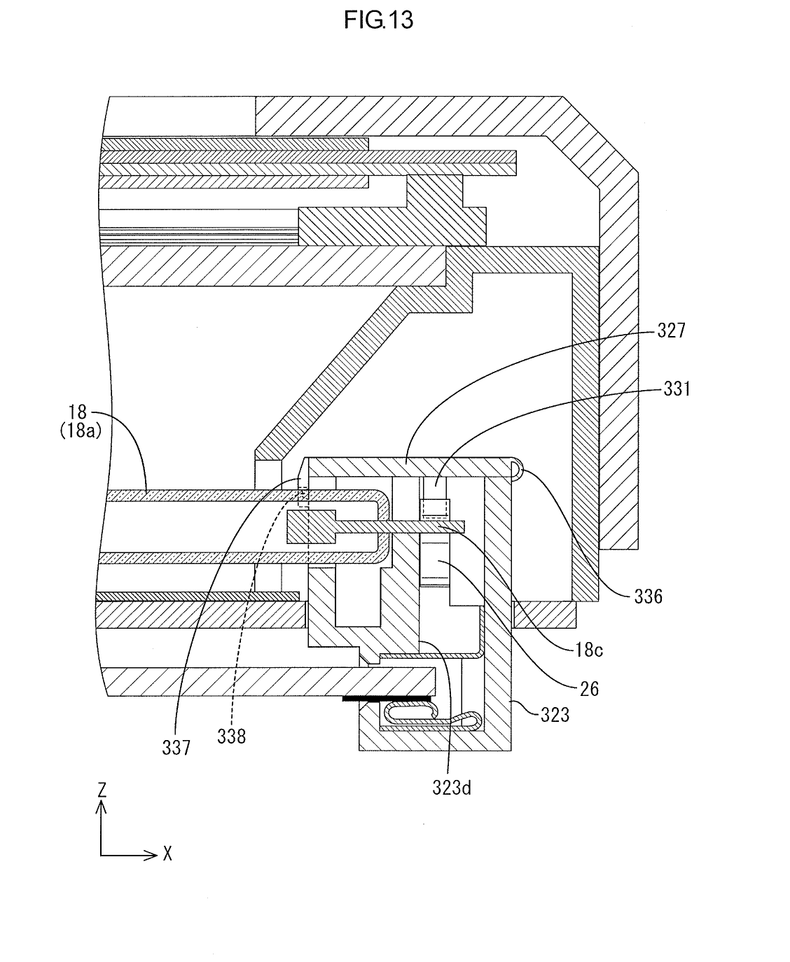

The fourth embodiment of the present invention will be explained using FIGS. 13 to 15. The fourth embodiment includes a restricting portion 327 that is different from the restricting portion of the second embodiment. Also, the structure, operation and effect same as those in the above second embodiment will not be explained.

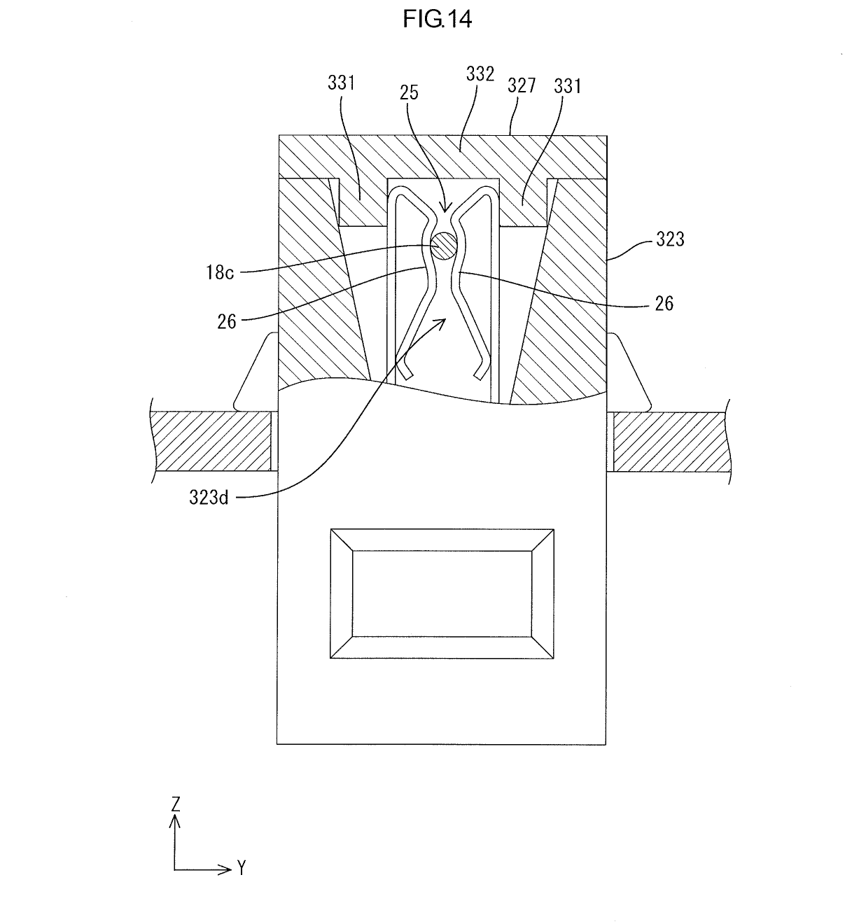

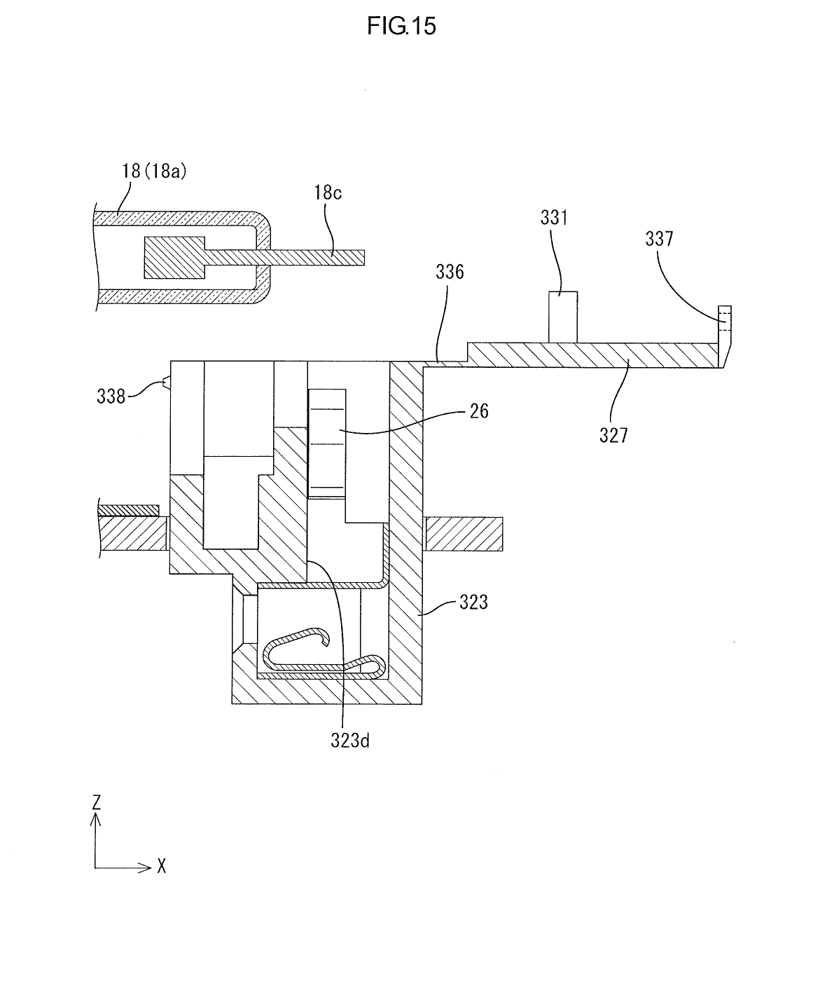

As illustrated in FIG. 13 and FIG. 14, the restricting portion 327 has substantially the same size as that of the connector housing 323 in the X-axis direction and Y-axis direction and has a lid shape that blocks a terminal housing room 323d. One end part of the restricting portion 327 in the X-axis direction is connected to the connector housing 323 via a hinge 336, and the other end part in the X-axis direction is separated from the connector housing 323. The hinge 336 connects the connector housing 323 and the outer portion of the restricting portion 327 in the X-axis direction, that is, the end part away from the cold cathode tube 18. The restricting portion 327 is rotatable around the hinge 336 with respect to the connector housing 323. A position of the restricting portion 327 illustrated in FIGS. 13 and 14 that closes the terminal housing room 323d and the insertion path 25 is a second position, and a position of the restricting portion 327 illustrated in FIG. 15 in which the terminal housing room 323d is opened and arranged adjacent to and outside of the connector housing 323 is a first position. In the first position, as illustrated in FIG. 15, the restricting portion 327 is arranged adjacent to and outside of the connector housing 323 in the X-axis direction, that is, in the axis direction of the cold cathode tube 18. In other words, the restricting portion 327 in the first position and the connector housing are not arranged adjacent to each other along the Y-axis direction, that is, outside of the connector housing 323 in a direction in which the cold cathode tubes 18 are arranged. As illustrated in FIG. 14, the middle portion of the restricting portion 327 in the Y-axis direction is an insertion restricting portion 332 that blocks the insertion path 25 and restricts an insertion of the outer lead 18c. On the inner surface of the restricting portion 327, a pair of expansion restricting portions 331 is provided to be away from each other with an interval therebetween same as the outer dimension of the pair of elastic contact parts 26 in the Y-axis direction. The restricting portion 327 according, to the present embodiment can directly press the end parts of the glass tube 18a of the cold cathode tube 18. Also, the other end part of the restricting portion 327 (the end part on the side opposite to the side of the hinge 36) is provided with a lock part 337, and the connector housing 323 is provided with a lock protrusion 338 that is fitted to the lock part 337. Accordingly, the restricting portion 327 is stably held in the second position.

As explained above, according to the present embodiment, the cold cathode tube 18 has a linear shape along the axis direction and a plurality of the cold cathode tubes 18 is arranged in parallel along a direction (Y-axis direction) crossing the axis direction (X-axis direction) and the insertion direction of the outer lead 18c with respect to the insertion path 25 (Z-axis direction). Further, in the first position, the restricting portion 327 is arranged adjacent to and outside of the connector housing 323 in the axis direction. With this configuration, the restricting portion 327 is not arranged between adjacent cold cathode tubes 18 in the first state, and therefore the restricting portion 327 is less likely to interfere with the adjacent cold cathode tubes 18. In other words, it is possible to freely set the interval between the adjacent cold cathode tubes 18 regardless of the restricting portion 327 and increase freedom in optical design of the backlight unit 12.

### Reference Example

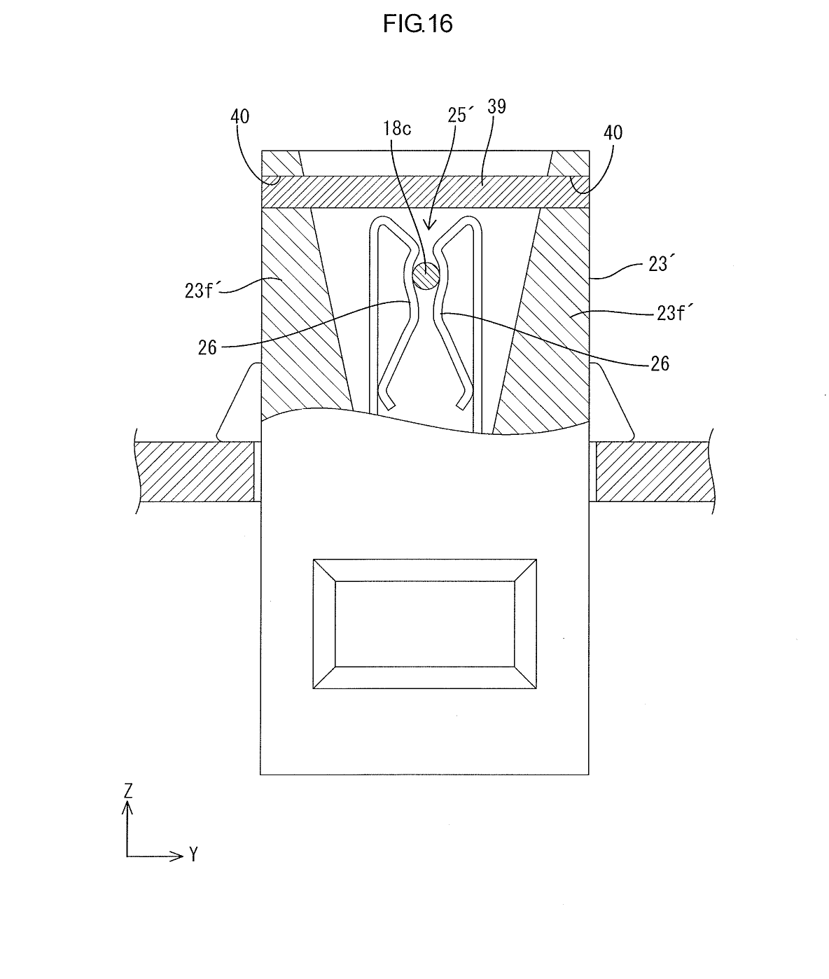

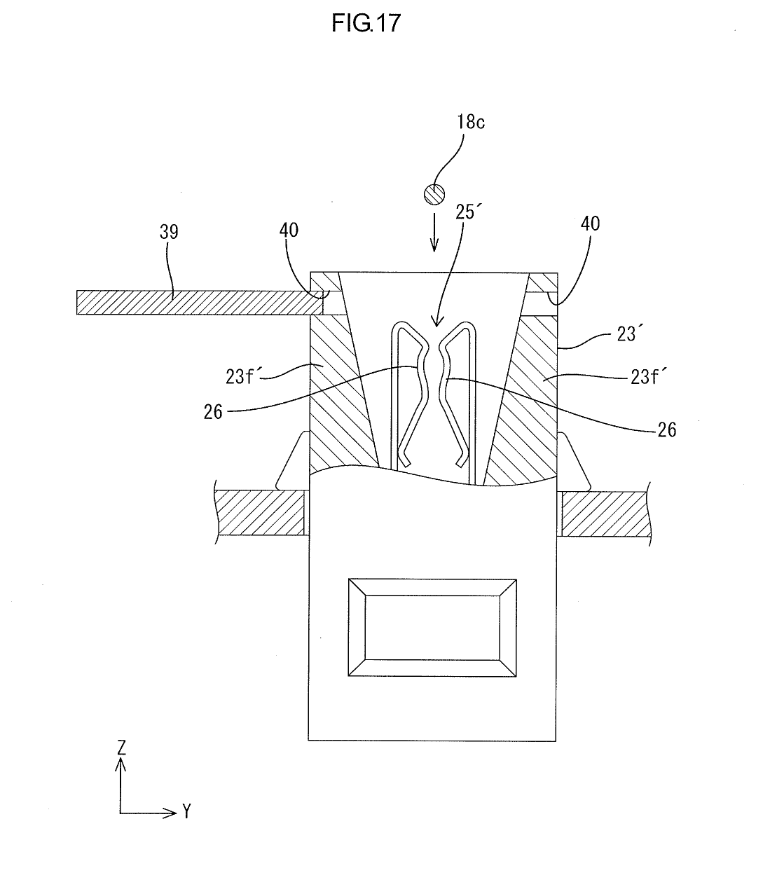

Next, the reference example will be explained using FIG. 16 or 17. This reference example includes a restricting portion 39 that restricts only an insertion of the outer lead 18c. The structure, operation and effect same as those in the above first embodiment will not be explained.

As illustrated in FIG. 16, the restricting portion 39 has a rod shape crossing a connector housing 23′ along the Y-axis direction and is attached to an attachment groove 40 formed in a side wall 23f′ of the connector housing 23′ and slidable along the Y-axis direction in the attachment groove 40. In a position illustrated in FIG. 16, the restricting portion 39 restricts an insertion of the outer lead 18c by blocking an insertion path 25′ of the outer lead 18c, and in a position illustrated in FIG. 17, the insertion path 25′ is opened and it allows insertion of the outer lead 18c. The restricting portion 39 does not restrict an expansion operation of the elastic contact part 26.

### Other Embodiment

The present invention is not limited to the above embodiments explained by the above description and figures. The following embodiments may be included in the technical scope of the present invention, for example.

(1) In the above first embodiment, a guide surface is provided in a connector housing and a slope surface parallel along the guide surface is also provided in a restricting portion. The guide surface on the connector housing side or the slope surface on the restricting portion side may not be provided. Even in such a case, the movement of the restricting portion to a direction inclined to the Z-axis direction is guided.

(2) In the first embodiment, the movement of a restricting portion is guided by a guide protrusion and a guide groove portion in addition to the guide surface of the connector housing and the slope surface of the restricting portion. The movement of the restricting portion may be guided only by the guide protrusion and the guide groove portion and the guide surface and slope surface may not be provided. The movement of the restricting portion may be guided by the guide surface or the slope surface and the guide protrusion and the guide groove portion may not be provided.

(3) In the first embodiment, the restricting portion separated from the connector housing is configured with a pair of restricting pieces. The restricting portion may be provided as one component. The restricting portion may be configured with three or more components.

(4) In the first embodiment, the pair of restricting pieces has a symmetrical shape (identical shape). The pair of restricting pieces may b have an asymmetrical shape (non-identical shape).

(5) In the first embodiment, the movement direction of the restricting portion is inclined to an insertion direction of an outer lead. The restricting portion may be moved in two stages, that is, it is moved along the insertion direction (Z-axis direction) of the outer lead in the first stage and moved along a direction (Y-axis direction) orthogonal to the insertion direction of the outer lead in the second stage.

(6) In the first embodiment, the restricting portion moves approximately linearly. The restricting portion may be moved curvilinearly. In this case, it is preferable that a curvilinear surface along the movement direction of the restricting portion is provided as a guide surface.

(7) In the third embodiment, the pair of restricting pieces integrally formed with the connector housing has a symmetrical shape (identical shape). The pair of restricting pieces may have an asymmetrical shape (non-identical shape).

(8) In the second to fourth embodiments, a restricting portion is integrally formed with a connector housing by a hinge. For example, the restricting portion may be separated from the connector housing and the restricting portion may be formed integrally with the connector housing by a hinge brace so as to be rotatable.

(9) In the above embodiments, a connection terminal has a pair of elastic contact parts sandwiching an outer lead. For example, only one elastic contact part may be provided and an receiving portion facing the elastic contact part may be provided such that an outer lead is sandwiched between the elastic contact part and the receiving portion.

(10) In the above embodiments, an end part of an inverter board may be inserted to and extracted from a connector. For example, it may be possible to pull out a lead wire from the connector to the rear side of a chassis and directly or indirectly connect the lead wire to the inverter board.

(11) In the above embodiments, a cold cathode tube has an outer lead projecting to an end part of a glass tube and the outer lead is connected to a connection terminal of a connector. For example, the end part of the glass tube may be provided with an external ferrule connected to the outer lead and the ferrule may be connected to the connection terminal.

(12) In the above embodiments, a straight cold cathode tube is used. For example, a horseshoe-shaped cold cathode tube or a curve-shaped cold cathode tube may be used.

(13) In the above embodiments, a cold cathode tube is used as a linear light source. Other kinds of discharge tubes such as a hot cathode tube may be used.

(14) In addition to the above embodiments, the number of light sources to be used may be adequately changed.

(15) In the above embodiments, a liquid crystal panel and a chassis are in a vertically-placed state in which their short side direction matches a vertical direction. The crystal panel and the chassis may be in a vertically-placed state in which their long side direction matches the vertical direction.

(16) In the above embodiments, TFT is used as a switching component of a liquid crystal display deice. The present technology is also applicable to a liquid crystal display device using switching components (such as a thin-film diode (TFD)) other than TFT. In addition, the present technology is applicable not only to a liquid crystal display device of colored display, but also to a liquid crystal display device of monochrome display.

(17) The above embodiments illustrate an example of a liquid crystal display device using a liquid crystal panel as a display panel. The present technology is also applicable to a display device using a display panel of a different type.

(18) The above embodiments illustrate an example of a television receiver having a tuner. The present technology is also applicable to a display device without a tuner.

### EXPLANATION OF SYMBOLS

10: Liquid crystal display device (Display device)
11: Liquid crystal panel (Display panel)
12: Backlight unit (Lighting device)
14: Chassis
18: Cold cathode tube (Light source)
18c: Outer lead (External connecting portion)
21: Inverter board (Electric power supply board)
22, 122: Connector
23, 123, 223, 323: Connector housing
24: Connection terminal
25: Insertion path
26: Elastic contact part
27, 127, 227, 327: Restricting portion
27A, 27B, 227A, 227B: Divided restricting portion
28: Guide surface
33: First holding protrusion (Holding structure)
34: Second holding protrusion (Holding structure)
35: Holding groove portion (Holding structure)
36, 236, 336: Hinge
C: Gap
TV: Television receiver

1. A lighting device comprising:
a light source having an external connecting portion at an end part;
a chassis housing the light source; and
a connector mounted to the chassis and including an insertion path to which the external connecting portion is inserted, a connection terminal configured to expand to receive the external connecting portion inserted to the insertion path, and a restricting portion configured to be selectively moved in one of a first position and a second position, wherein:
the restricting portion positioned in the first position allows the external connecting portion to be inserted to the insertion path and allows the connection terminal to expand to receive the external connecting portion; and
the restricting portion positioned in the second position restricts the external connecting portion to be inserted to the insertion path and restricts expansion of the connection terminal that holds the external connection portion therein.

2. The lighting device according to claim 1, wherein:
the connector includes a connector housing mounted to the chassis and configured to house the connection terminal; and
the restricting portion is provided separately from the connector housing.

3. The lighting device according to claim 2, wherein the restricting portion moves approximately linearly between the first position and the second position.

4. The lighting device according to claim 3, wherein the restricting portion moves in a movement direction that is inclined to an insertion direction in which the external connecting portion is inserted to the insertion path.

5. The lighting device according to claim 4, wherein at least one of the restricting portion and the connector housing has a guide surface that is inclined to the insertion direction in which the external connecting portion is inserted to the insertion path and guides movement of the restricting portion.

6. The lighting device according to claim 4, wherein:
the restricting portion includes a pair of restricting pieces;
the pair of restricting pieces are separated from each other and form a space therebetween that is communicated to the insertion path in the first position; and
the pair of restricting pieces are closer to each other to narrow the space as the restricting pieces move from the first position to the second position.

7. The lighting device according to claim 6, wherein the pair of restricting pieces has a symmetrical shape.

8. The lighting device according to claim 2, further comprising a holding structure provided on the restricting portion and the connector housing and configured to hold the restricting portion with respect to the connector housing selectively in one of the first position and the second position.

9. The lighting device according to claim 1, wherein:
the connector includes a connector housing that is mounted to the chassis and configured to house the connection terminal; and
the restricting portion is integrally formed with the connector housing.

10. The lighting device according to claim 9, wherein the restricting portion is connected to the connector housing via a hinge and rotatably moves around the hinge between the first position and the second position.

11. The lighting device according to claim 10, wherein:
the light source is formed in a linear shape having an axis; and
the restricting portion that is positioned in the first position is arranged in adjacent to and outside of the connector housing in a direction crossing both the axis and an insertion direction in which the external connecting portion is inserted to the insertion path.

12. The lighting device according to claim 11, wherein the restricting portion has one end side connected to the connector housing by the hinge and another end side separated from the connector housing.

13. The lighting device according to claim 11, wherein:
the restricting portion includes a pair of restricting pieces; and
an end part of one of the restricting pieces that is away from another restricting piece in the second position is connected to the connector housing by the hinge.

14. The lighting device according to claim 10, wherein:
the light source includes a plurality of light sources and each of the light sources has a linear shape having an axis and the light sources are arranged in parallel to each other along a direction crossing the axis and an insertion direction in which the external connecting portion is inserted to the insertion path; and
the restricting portion in the first position is arranged in adjacent to and outside of the connector housing along the axis.

15. The lighting device according to claim 1, wherein the connection terminal includes a pair of elastic contact parts that are configured to be elastically in contact with the external connecting portion.

16. The lighting device according to claim 1, further comprising an electric power supply board configured to supply drive electric power to the light source and arranged on a side opposite to the light source with respect to the chassis,
wherein the connector electrically relay-connects the electric power supply board and the light source.

17. The lighting device according to claim 1, wherein the light source is configured with a cold cathode tube.

18. A display device comprising the lighting device according to claim 1 and a display panel that performs display using a light from the lighting device.

19. The display device according to claim 18, wherein the display panel is a liquid crystal panel obtained by sealing a liquid crystal between a pair of boards.

20. A television receiver comprising the display device according to claim 18.
